(19) United States
(12) Patent Application Publication
(10) Pub. No.: US 2026/0289266 A1
(43) Pub. Date: Sep. 24, 2026

(54) SYSTEM

(71) Applicant: SoftBank Group Corp., Tokyo (JP)

(72) Inventor: Tomoko TSUJIMURA, Tokyo (JP)

(73) Assignee: SoftBank Group Corp., Tokyo (JP)

(21) Appl. No.: 19/565,610

(22) Filed: Mar. 13, 2026

(30) Foreign Application Priority Data
Mar. 19, 2025 (JP) 2025-044513

(51) Int. Cl. G06N 3/0475; G06F 16/335

(52) U.S. Cl. CPC G06N 3/0475; G06F 16/337

(57) ABSTRACT

A system includes a processor that is configured to use an application programming interface of a messaging application to collect performance data of users, analyze the collected data using statistical techniques and machine learning algorithms to identify specific patterns and trends, and generate a prompt based on an analysis result, the prompt being configured to instruct a generative artificial intelligence model to generate an operational proposal.

### CROSS-REFERENCE TO RELATED APPLICATION

This application is based on and claims priority under 35 USC 119 from Japanese Patent Application No. 2025-044513 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional operation support systems for messaging-based services are typically limited to simple analytics dashboards and rule-based recommendations. Such systems are not capable of flexibly leveraging large amounts of user performance data, emotional states, and generative artificial intelligence models in an integrated manner. As a result, an operator must manually interpret statistical graphs, derive patterns and trends, and draft appropriate prompts or instructions for generative artificial intelligence models in order to obtain meaningful operational proposals, such as message scheduling, content optimization, or user targeting strategies. This manual workflow is time-consuming, requires specialized analytical skills, and does not scale well as the volume and complexity of data increase. In addition, conventional systems do not adequately quantify user emotions derived from message interactions or text content, and therefore cannot effectively reflect emotional information in the generation of operational proposals. Accordingly, there is a need for a system that can automatically collect performance data of users from a messaging application, analyze the collected data to identify patterns and trends, quantify user emotions, and construct appropriate prompts for a generative artificial intelligence model so that the generative artificial intelligence model can automatically generate high-quality operational proposals without requiring extensive manual intervention by the operator.

### SUMMARY

In order to solve the above-described problems, a system according to one aspect of the present invention comprises a processor, wherein the processor is configured to use an application programming interface of a messaging application to collect performance data of users, analyze the collected data using statistical techniques and machine learning algorithms to identify specific patterns and trends, and generate a prompt based on an analysis result, the prompt being configured to instruct a generative artificial intelligence model to generate an operational proposal. According to another aspect, the processor is further configured to apply a text mining technique to analyze emotions of the users, convert an emotional state into a numerical value, and provide a result of the emotional analysis to the generative artificial intelligence model. According to still another aspect, the processor is configured to input a prompt sentence and an emotional analysis result into the generative artificial intelligence model and cause the generative artificial intelligence model to generate the operational proposal. By integrating performance data analysis, emotion quantification, and prompt generation in this manner, the system can automatically and adaptively generate operational proposals that reflect both behavioral patterns and emotional states of users in the messaging application environment.

The term “system” refers to a combination of hardware and software components including at least one processor and, optionally, memory, storage, communication interfaces, and executable programs that cooperate to perform the functions described in the claims and specification.

The term “processor” refers to one or more hardware processing units, such as a central processing unit (CPU), a graphics processing unit (GPU), a digital signal processor (DSP), or any other circuitry capable of executing instructions to perform logical, arithmetic, and control operations.

The term “messaging application” refers to a software application or service that enables electronic exchange of messages between users or between a user and a service, including but not limited to mobile messaging apps, web-based chat services, and enterprise messaging platforms.

The term “application programming interface of a messaging application” refers to a programmatically accessible interface, such as a set of functions, endpoints, or protocols, that allows external systems to send requests to and receive responses from the messaging application, including operations to access user-related performance data.

The term “performance data of users” refers to data representing how users interact with messages or services provided through the messaging application, including but not limited to delivery counts, open counts, click counts, response actions, message viewing time, and other behavioral indicators.

The term “statistical techniques” refers to one or more methods based on statistics for analyzing data, including but not limited to calculation of averages, variances, distributions, correlations, regressions, clustering, and hypothesis testing.

The term “machine learning algorithms” refers to computational methods that learn patterns or models from data, including but not limited to supervised learning algorithms, unsupervised learning algorithms, reinforcement learning algorithms, neural networks, and deep learning models.

The term “patterns and trends” refers to recurring relationships, structures, or temporal changes found in the performance data, such as typical user behavior sequences, correlations between message attributes and user responses, seasonal effects, or time-of-day effects.

The term “analysis result” refers to processed information derived from applying statistical techniques and machine learning algorithms to the collected performance data, including metrics, models, detected patterns, and identified trends.

The term “prompt” refers to a text or structured input provided to a generative artificial intelligence model, the input specifying a task, constraint, context, or instruction that guides the generative artificial intelligence model in producing an output.

The term “generative artificial intelligence model” refers to an artificial intelligence model that generates new data or content, such as natural language text, in response to an input, and includes models such as large language models, transformer-based models, and other generative models trained on large datasets.

The term “operational proposal” refers to information generated by the generative artificial intelligence model that suggests actions or strategies for operating or optimizing a service, including but not limited to recommendations for message timing, content, segmentation, targeting, or campaign design.

The term “text mining technique” refers to a method for processing and analyzing text data in order to extract useful information, including but not limited to tokenization, part-of-speech tagging, sentiment analysis, topic extraction, and keyword detection.

The term “emotions of the users” refers to inferred emotional states associated with users or their interactions, such as positive, negative, neutral, or more granular emotional categories, derived from message content, responses, or behavioral patterns.

The term “emotional state” refers to a representation of a user's or a group of users'emotional condition at a certain time or in response to certain content, as inferred by text mining techniques or other analytical methods.

The term “convert an emotional state into a numerical value” refers to the process of representing an inferred emotional state in quantitative form, such as a sentiment score, probability distribution over emotion categories, or a vector embedding in a numerical space.

The term “emotional analysis result” refers to the output of processing performed to determine and quantify emotions of the users, including numerical scores, labels, or other structured representations of emotional states.

The term “prompt sentence” refers to a textual form of the prompt that is provided as natural language input to the generative artificial intelligence model to specify or describe the desired operational proposal.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

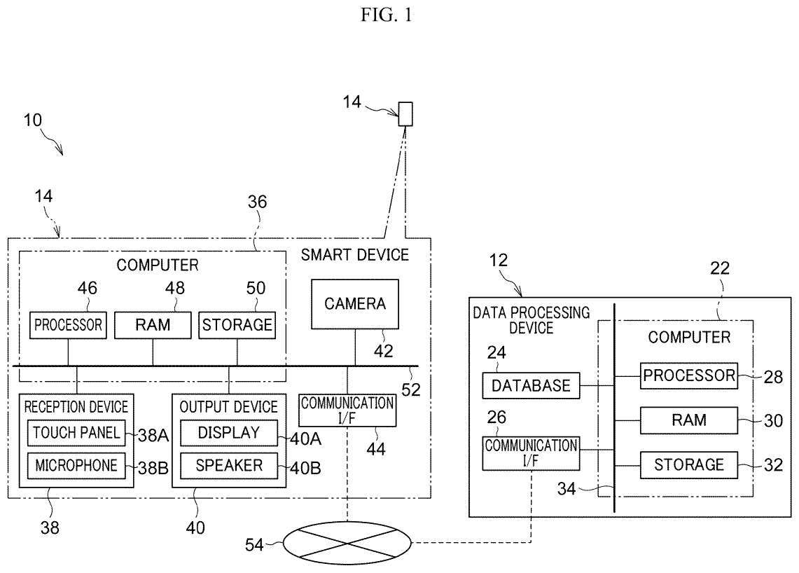

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

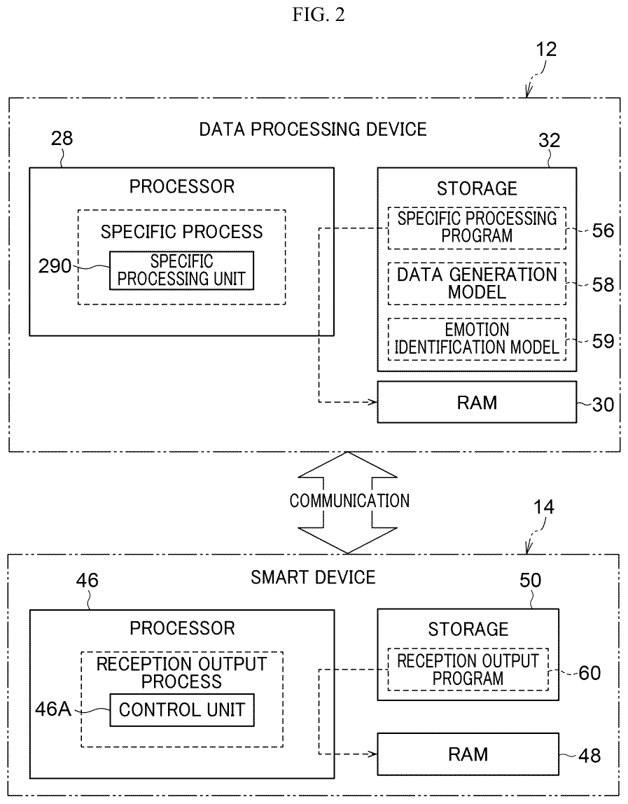

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In content distribution businesses utilizing communication or messaging applications, large volumes of performance information such as viewing indicators, selection indicators, reaction indicators, and distribution timestamps are continuously generated. Conventional systems typically require human operators or ad hoc scripts to manually collect such information from an application programming interface, preprocess the information, apply analytical methods, and then draft operation proposals. These conventional approaches are often fragmented and tool-dependent, for example relying on separate data extraction tools, spreadsheet software, and generic machine learning utilities, with little integration or automation across the end-to-end workflow. As a result, the generation of high-quality operation proposals is slow, labor-intensive, and error-prone.

Moreover, in traditional architectures, even when statistical or machine learning analysis is performed, the results are usually stored as numerical tables or static reports that are not directly consumable by automated proposal-generation components. There is no standardized mechanism for transforming analysis results into structured natural-language prompt sentences suitable for generative AI models. Consequently, operators must manually interpret analytical outputs and then manually craft instructions for a generative AI model, which introduces latency, inconsistency, and dependency on individual skills, and which limits scalability.

Further, conventional systems do not effectively incorporate user-specific contextual information such as emotional state into the generation of operational proposals. Emotional information, if present at all, is typically handled separately from performance indicators and is not systematically integrated into machine-interpretable prompts for generative AI models. This prevents the system from adapting proposals to nuanced user contexts and reduces the relevance and effectiveness of generated proposals.

From a computer technology perspective, these limitations result in suboptimal utilization of computing resources and network interfaces. Multiple disparate processes repeatedly access remote interfaces and storage systems without coordinated control, creating redundant data transfers and unnecessary computation. There is no unified processing pipeline implemented in a processor that is configured to: (i) automatically collect performance information from an application interface, (ii) transform the information into time-attribute-based analytical features, (iii) generate structured natural-language prompt sentences embedding such analytical features, and (iv) interface with generative AI models to obtain operation proposals and deliver them to terminal devices. This lack of integration leads to increased latency, reduced throughput, and poor reproducibility of analysis and proposal generation across computing environments.

Accordingly, there is a need for a technical solution that improves computer functionality by providing an integrated processing architecture in which a processor automatically performs performance-information acquisition, time-based aggregation and trend extraction, prompt sentence construction, generative AI invocation, and proposal delivery. There is further a need to systematically encode user emotional states as numerical indices and to embed those indices into the prompt sentences so that the generative AI model can generate proposals that are both data-driven and context-aware, thereby improving the quality, relevance, and efficiency of operation proposal generation in computer-implemented content distribution systems.

The specific processing by the specific processing unit 290 of the data processing device 12 in Example 1 is realized by the following means.

The present invention provides a server comprising a processor configured to connect, via a communication function, to an application programming interface of an information providing application and acquire performance information related to a user, thereby collecting, for a predetermined period, performance information including viewing indicators, selection indicators, reaction indicators, and time information for distributed information; read the performance information from a storage device and assign time attributes based on the time information by using a general-purpose information processing program, and execute aggregation processing and trend extraction processing for each time attribute by using a statistical processing program or a machine learning program, thereby identifying tendencies of the viewing indicators, the selection indicators, and the reaction indicators for predetermined time zones or dates; construct analysis results indicating the tendencies as explanation information in a natural language format and generate an instruction sentence including the explanation information, thereby generating a prompt sentence that instructs a generative AI model to create an operation proposal; input the prompt sentence to an external generative AI model or an internal generative AI model and obtain, in a natural language format, operation proposal information regarding distribution time and distribution content based on the analysis results; configure the operation proposal information as notification data to be notified to a terminal device and transmit the notification data toward the terminal device so that a user can view the operation proposal information; and, in certain embodiments, analyze expression information acquired from the user by using a text analysis program, calculate an emotion index as numerical information indicating an emotional state, include the emotion index in the prompt sentence, and input the prompt sentence and the emotion index to the generative AI model so that the generative AI model generates the operation proposal information based on both tendencies of the performance information and the emotion index. This enables an integrated computer-implemented processing pipeline in which the server efficiently transforms raw performance information and user emotional context into structured prompt sentences for a generative AI model, automatically generates context-aware operation proposals, reduces manual intervention, improves utilization of computational and communication resources, and enhances the technical performance and responsiveness of content distribution systems.

The term “system” refers to an arrangement including at least one hardware apparatus and software component configured to execute the claimed processing, such as a server, storage device, network interface, and associated programs.

The term “processor” refers to a hardware processing unit, such as a central processing unit or a programmable processing device, configured to execute instructions for performing the claimed functions.

The term “communication function” refers to hardware and software components that enable data transmission and reception over a communication network, such as network interfaces, communication protocols, and communication control programs.

The term “information providing application” refers to an application program or service that distributes digital content to users and exposes an application programming interface for accessing information related to such distribution.

The term “application programming interface” refers to an interface defined by software or a service that enables programmatic access to data or functions of the information providing application.

The term “performance information” refers to data indicating results of content distribution, including but not limited to viewing indicators, selection indicators, reaction indicators, and time information relating to distributed information.

The term “viewing indicator” refers to a value representing the extent to which distributed information has been displayed or accessed by users, such as a count of views or impressions.

The term “selection indicator” refers to a value representing the extent to which distributed information has been actively selected or accessed in response to an option, such as a count of selections or click-throughs.

The term “reaction indicator” refers to a value representing subsequent user responses to distributed information, such as engagement, feedback, or interaction metrics.

The term “time information” refers to information indicating a time or date associated with an event, such as a timestamp of distribution or access of distributed information.

The term “terminal device” refers to an end-user device capable of receiving and presenting information, such as a mobile communication device, a portable information processing device, or a stationary information processing device.

The term “storage device” refers to a hardware apparatus that stores data, such as a magnetic storage device, a semiconductor storage device, or an optical storage device.

The term “general-purpose information processing program” refers to software configured to perform non-specialized data processing, including data conversion, formatting, and manipulation operations.

The term “statistical processing program” refers to software configured to execute statistical operations on data, such as aggregation, averaging, variance calculation, or correlation analysis.

The term “machine learning program” refers to software configured to execute machine learning algorithms that analyze data to identify patterns, trends, or predictive relationships.

The term “time attribute” refers to a classification or feature derived from time information, such as a time zone, time of day, weekday, or date category.

The term “aggregation processing” refers to processing that combines multiple data values into representative values, such as sums, averages, or grouped counts.

The term “trend extraction processing” refers to processing that analyzes changes or patterns in data over time or across attributes to identify tendencies or trends.

The term “analysis result” refers to information obtained by processing performance information through aggregation processing and trend extraction processing, indicating identified tendencies or patterns.

The term “explanation information” refers to information that describes the analysis result in a human-readable natural language format.

The term “instruction sentence” refers to a natural language sentence or set of sentences that instructs a model or program to perform a particular task, based on explanation information.

The term “prompt sentence” refers to a natural language instruction, including explanation information and optionally additional parameters, that is provided as input to a generative AI model to cause generation of operation proposal information.

The term “generative AI model” refers to a computational model that generates output content, such as natural language text, based on input data or prompt sentences, and that may include a neural network model or other generative model.

The term “external generative AI model” refers to a generative AI model executed by a computing resource that is separate from the server, accessed via a communication network.

The term “internal generative AI model” refers to a generative AI model executed by a computing resource that is included in or directly controlled by the server.

The term “operation proposal information” refers to information that provides recommendations or guidelines for operating or managing content distribution, including information on distribution time and distribution content.

The term “notification data” refers to data formatted for transmission to a terminal device to notify a user of operation proposal information.

The term “expression information” refers to information representing user expressions, such as text messages, comments, or other user-generated content suitable for text analysis.

The term “text analysis program” refers to software configured to process text data, including segmentation, parsing, feature extraction, and analysis for deriving attributes such as emotional state.

The term “emotion index” refers to numerical information indicating an emotional state of a user, derived from expression information by the text analysis program.

In one embodiment, a server implements the claimed system by executing computer programs on general-purpose hardware. The server includes at least one central processing unit, a main memory, a nonvolatile storage device, and a network interface. The server executes an operating system such as a general-purpose server operating system, and runs application programs including an HTTP client library, a database management system client, a data analysis library (for example, a Python environment with a data frame library and a statistical/machine learning library), and a generative AI client library configured to communicate with a generative AI model. The server stores performance information and operation proposal information in a database system such as a relational database. A terminal is implemented as a communication-capable device, such as a smartphone or a tablet computer, which executes a client application configured to receive notification data from the server and display operation proposal information. A user operates the terminal to view proposals and to supply expression information, such as text input, to the server.

The server acquires performance information from an information providing application via an application programming interface. The information providing application may be realized by a content distribution platform that offers an HTTP-based REST API. The server uses a communication function of the network interface and an HTTP client library to transmit authenticated requests to the API over a packet-based network. The server receives response data, for example in JavaScript Object Notation (JSON) format, including distribution event records for a predetermined period. Each record contains performance information fields including a content identifier, a viewing indicator, a selection indicator, a reaction indicator, and time information representing a distribution timestamp or access timestamp.

The server writes the received performance information into a structured data store. The server maps the JSON fields into columns of one or more database tables. In one example, a table includes columns such as “content_id,” “user_id,” “view_count,” “click_count,” “engagement_score,” and “delivered_at.” The server uses a database client library to execute insert or update operations under transactional control. By storing performance information in a normalized schema, the server reduces redundancy and enables efficient indexed queries, which improves data access latency and throughput when performing subsequent analytical processing.

The server reads performance information for a specified observation window from the storage device into main memory. The server uses a data analysis library, for example a data frame library in a Python environment, to construct an in-memory tabular data structure. The server converts the time information into a machine-readable timestamp representation and derives a time attribute for each record, such as “weekday,” “hour_of_day,” or a composite index (weekday, hour). The server computes these attributes by applying deterministic transformations to the timestamp (e.g., modular arithmetic for hours and mapping functions for weekdays). By materializing time attributes as explicit data columns, the server enables vectorized aggregation operations on the data frame structure, which significantly reduces computation time compared to row-by-row iteration.

The server executes aggregation processing and trend extraction processing using a statistical processing program or a machine learning program. For aggregation, the server groups records by one or more time attributes and computes summary statistics such as mean viewing indicator, mean selection indicator, and mean reaction indicator per group. The server may also compute measures of dispersion such as standard deviation to identify stable patterns versus outliers. For trend extraction, the server may apply a regression model (e.g., linear regression or logistic regression implemented in a statistical library) or a time-series analysis algorithm (e.g., moving average or exponential smoothing) to estimate how performance indicators depend on time attributes. In another embodiment, the server uses a supervised machine learning algorithm such as gradient boosting or random forests to model the conditional relationship between time attributes and performance indicators. The server derives tendencies such as “time slots with predicted high viewing indicator” by evaluating the model for each candidate time attribute combination and ranking the predicted values.

The server converts the analysis results into explanation information in natural language. The server implements rule-based formatting in which numeric results are mapped into text templates. For example, when the mean viewing indicator for a specific time slot exceeds a global baseline by a predetermined threshold, the server generates a sentence of the form: “The average view count on [weekday] between [start time] and [end time] is [percentage] higher than the overall average.” The server concatenates such sentences into a coherent explanation paragraph. This explanation information explicitly encodes, as text, the statistical tendencies that the server has computed. By performing this structured transformation, the server creates a machine-generated natural language representation that is consistent across executions and is suitable for inclusion in a prompt sentence.

The server generates a prompt sentence to be provided to a generative AI model. The server maintains a prompt template containing fixed instructions for the generative AI model and places placeholders for insertion of explanation information and optional additional constraints. In one example, the server constructs a prompt sentence such as:
“The following is an analysis of our article distribution performance over the past 30 days:
Average views are 25% higher on Wednesdays between 18:00 and 20:00 compared to the overall average.
Click-through rate is highest for technology and business news headlines.
Engagement rate is low on weekend mornings (Saturday and Sunday, 8:00-11:00).
Based on this analysis, please generate specific operational proposals for:
1) Optimal days and time slots for delivering articles, and
2) Recommended article topics and headline styles.
Please provide the answer in English, in bullet-point format.”

In this example, the server automatically inserts updated numeric values, time slots, and content categories based on the current analysis results. The server thereby produces a prompt sentence that is tightly coupled to the computed tendencies and that provides detailed context to the generative AI model.

In another embodiment, the server incorporates user emotional context into the prompt sentence. The server receives expression information from the terminal, such as text messages entered by the user. The server uses a text analysis program, for example a natural language processing pipeline including tokenization, part-of-speech tagging, and sentiment classification. The sentiment classification may be realized as a neural network model trained on labeled text data, such as a bidirectional recurrent neural network or a transformer encoder, which outputs an emotional score along predefined dimensions (e.g., positivity, stress, or motivation). The server normalizes these scores to compute an emotion index, such as a scalar value or a small vector of values. The server then embeds a natural language description of the emotional state, derived from the emotion index, into the prompt sentence. For example, the server may insert a phrase: “The user is currently experiencing high stress and low motivation based on recent messages.” By encoding the emotion index into natural language and, optionally, also passing it as structured metadata, the server enables the generative AI model to tailor operation proposal information to the user's contextual state.

The server transmits the prompt sentence to a generative AI model. In one implementation, the generative AI model is provided as an external service, such as a cloud-hosted text generation model. In another implementation, the generative AI model is implemented internally on the same hardware platform or on a local accelerator device such as a graphics processing unit. The generative AI model may be realized as a transformer-based neural network including an embedding layer, multiple self-attention layers, feed-forward layers, and an output layer that predicts a probability distribution over tokens. The model is pre-trained on large corpora of text and optionally fine-tuned on operation proposal examples.

The server configures model parameters such as maximum output length, sampling temperature, and decoding strategy (e.g., greedy decoding or beam search). The server encodes the prompt sentence into token identifiers using a tokenizer compatible with the generative AI model and sends these tokens as input. Inside the model, each token is mapped to a vector representation by the embedding layer, then processed through stacked attention layers that compute attention scores over the prompt context, and through non-linear transformations in feed-forward sublayers. At each generation step, the model applies a softmax function over the output logits to obtain a probability distribution for the next token. The server may restrict candidate tokens by applying domain-specific constraints, such as forbidding tokens that would generate unsupported time formats, to improve proposal precision. By imposing such constraints, the server modifies the decoding process in a way that reduces invalid outputs, thereby technically improving the reliability of the generated operation proposal information.

To train the generative AI model in one embodiment, a training system uses historical pairs of (prompt sentence, desired proposal) created by expert operators. The training algorithm computes a loss function, such as cross-entropy between the model's output token distribution and the ground-truth tokens, and updates model weights by backpropagation and stochastic gradient descent or a variant thereof (e.g., Adam optimizer). Data augmentation techniques may be used to vary time attributes, performance statistics, and emotional descriptions so that the model learns to generalize across different scenarios. This training process results in a model that can infer consistent proposal structures from diverse prompt sentences, allowing the server to obtain high-quality text with fewer model calls and improved consistency.

The server receives the generated text from the generative AI model as operation proposal information. The server post-processes the text by performing formatting and validation. For example, the server parses the generated text to identify explicit time expressions and content category names using pattern matching or rule-based extraction, and checks that recommended time slots fall within allowed scheduling windows configured in the system. When inconsistencies or ambiguous expressions are detected, the server may invoke a secondary rule-based normalization procedure to resolve them or may re-issue a modified prompt sentence that clarifies constraints. This feedback integration between structured validation and generative output prevents invalid proposals from being shown at the terminal and improves the overall robustness of the system.

The server configures the validated operation proposal information as notification data and transmits it to the terminal. The server uses a push notification service or an in-application messaging function to deliver a compact summary along with a reference to the full proposal. The terminal receives the notification data via its network interface and invokes a client application. The terminal requests the full proposal content from the server and displays the proposal on a user interface screen, organizing recommendations into sections such as “Recommended Time Slots,” “Recommended Topics,” and “Sample Headlines.” The user can scroll through the proposal, mark certain recommendations as accepted or rejected, or request additional detail, and the terminal transmits such user actions back to the server for logging and potential use in future training or configuration of the generative AI model.

The described configuration provides technical effects beyond mere automation of human tasks. By integrating the acquisition of performance information, the derivation of time attributes, the aggregation and trend extraction, and the generation of structured prompt sentences within a single server-controlled pipeline, the system reduces the number of redundant data transfers between heterogeneous tools and avoids manual export/import steps that normally require human intervention. This leads to lower end-to-end latency and reduces the computational overhead associated with repeated parsing and transformation of the same data. Furthermore, the use of vectorized data frame operations and model-based prediction of high-performance time slots results in more efficient utilization of CPU and memory resources than naïve, script-based processing. The server's enforcement of domain-specific constraints during generative decoding also reduces the need for post-hoc manual correction of proposals, which in turn decreases network round trips and storage writes for rejected proposals.

Additionally, the incorporation of an emotion index as a numerical feature, processed by a dedicated text analysis program and systematically integrated into the prompt sentence, enables a type of contextual adaptation that is not achievable by simple human scripting. The server encodes user emotional state using quantifiable metrics derived by a neural classifier, and then leverages these metrics to bias the content and tone of generated operation proposal information. This pipeline represents a technical improvement in how a computer system models and uses user state information to control downstream text generation, and it operates according to algorithmic rules and learned parameters that differ from typical human heuristics.

In alternative embodiments, the server may employ different internal architectures for the generative AI model, such as encoder-decoder transformers or hybrid models that combine rule-based templates with neural generation. The server may also vary the structure of time attributes, for example by introducing features such as “holiday indicator” or “campaign phase” derived from a calendar service. The server may deploy the model on specialized hardware accelerators to further reduce latency, or may shard the model across multiple processing units to increase throughput. The terminal may additionally cache recent operation proposal information to reduce repeated data transfers, further improving communication efficiency.

Through these configurations, the server, terminal, and user interact via specific, technically detailed data structures and algorithms. The server does not merely perform generic data retrieval and display, but rather executes a coordinated sequence of time-aware aggregation, model-guided generation, constrained decoding, and device-specific notification, which collectively improve processing speed, accuracy of recommendations, and utilization of computational and communication resources in a content distribution environment.

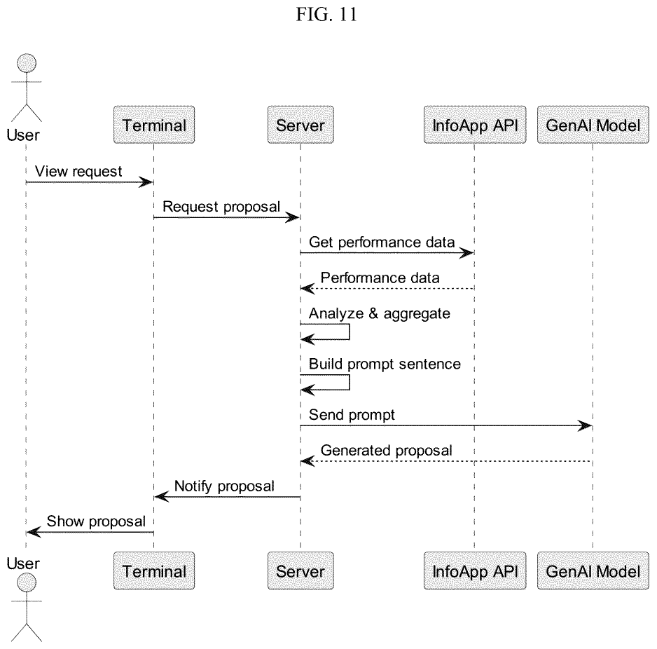

The following describes the processing flow using FIG. 11.

### Step 1:

The server acquires performance information from an information providing application via an application programming interface.
Input: API endpoint URL, authentication credentials, and a time range specifying a target period.
The server sends an authenticated HTTP request containing the time range parameters to the application programming interface. The server receives response data in a structured format including fields such as content identifier, viewing indicator, selection indicator, reaction indicator, and distribution timestamp. The server validates the HTTP status code and the schema of the response. The server filters out records that fall outside the requested period or lack mandatory fields.
Output: A validated collection of performance records, each record including at least a content identifier, performance indicators, and time information.

### Step 2:

The server stores the acquired performance information into a structured data store.
Input: The validated collection of performance records from Step 1.
The server opens a connection to a database system and maps each performance record into a row of one or more tables with predefined columns such as content_id, user_id, view_count, click_count, engagement_score, and delivered_at. The server executes insert or update operations for each record, using indexes on keys such as content_id and delivered_at to speed up access. The server commits the transaction after all records are processed and logs the number of inserted and updated rows.
Output: A set of database tables persistently storing normalized performance information indexed by content identifier and time.

### Step 3:

The server loads performance information for an analysis period and derives time attributes.
Input: A specification of the analysis period (for example, the last 30 days) and the database tables created in Step 2.
The server executes a database query to extract all performance records whose delivered_at field falls within the analysis period. The server loads the query result into an in-memory tabular data structure, such as a data frame. The server converts each delivered_at value into a timestamp object and computes derived time attributes such as weekday and hour_of_day using deterministic mapping functions. The server appends these derived attributes as additional columns in the data frame.
Output: An augmented data frame containing performance indicators and associated time attributes for each record.

### Step 4:

The server executes aggregation processing based on time attributes.
Input: The augmented data frame from Step 3.
The server groups the data by one or more time attributes, for example by weekday and hour_of_day. Within each group, the server calculates summary statistics such as average view_count, average click_count, average engagement_score, and the number of observations. The server may also compute standard deviation or confidence intervals to assess stability. The server constructs a new aggregated data structure where each entry corresponds to a unique combination of time attributes and its associated summary metrics.
Output: An aggregated data set representing performance indicators summarized for each time-attribute combination.

### Step 5:

The server performs trend extraction and identifies high-performance time slots.
Input: The aggregated data set from Step 4.
The server computes a global baseline for each performance indicator, such as the mean view_count across all time-attribute combinations. The server compares each group's summary metrics to the corresponding baseline. For each time-attribute combination, the server calculates a deviation metric, for example percentage difference from the baseline. The server ranks the time-attribute combinations by deviation and selects those whose deviation exceeds a predefined threshold as candidate high-performance slots. Optionally, the server applies a regression or time-series model over the aggregated metrics to smooth noise and confirm consistent trends.
Output: A set of trend descriptors identifying time-attribute combinations with relatively high or low performance, along with associated deviation metrics.

### Step 6:

The server converts trend descriptors into natural-language explanation information.
Input: The set of trend descriptors from Step 5.
The server iterates over each trend descriptor and applies rule-based text templates. For example, when the average view_count for a given weekday and hour range exceeds the baseline by a threshold, the server fills a template: “Average views on [weekday] between [start time] and [end time] are [percentage]% higher than the overall average.” The server repeats this process for selection indicators and reaction indicators, generating sentences for significant positive or negative deviations. The server concatenates the sentences into paragraphs and orders them by significance or by time attribute.
Output: A natural-language explanation text that summarizes statistical tendencies of performance indicators across time attributes.

### Step 7:

The server analyzes user expression information and computes an emotion index.
Input: Expression information received from the terminal, such as user-generated text, and a text analysis program with a trained sentiment model.
The server tokenizes the expression information into linguistic units and encodes them into numerical vectors using an embedding method. The server feeds the embedded vectors into a sentiment classification model, such as a recurrent neural network or a transformer encoder, which outputs scores along one or more emotional dimensions. The server normalizes and combines these scores into an emotion index, for example a scalar or a vector representing positivity, stress level, or motivation level. The server may discretize the emotion index into qualitative categories for interpretation.
Output: An emotion index representing the user's current emotional state and, optionally, a textual description of that state.

### Step 8:

The server composes a prompt sentence for a generative AI model.
Input: The natural-language explanation text from Step 6 and the emotion index from Step 7 (if available).
The server loads a predefined prompt template that specifies instructions for operation proposal generation. The server inserts the explanation text into a designated section labeled as “analysis of article distribution performance.” If the emotion index is present, the server inserts a sentence describing the emotional context, such as “The user is currently experiencing high stress and low motivation based on recent messages.” The server appends explicit instructions describing the required output format and constraints, for example requesting bullet-point proposals and specifying that the response be in a certain language. The server concatenates these components into a single prompt sentence or multi-paragraph prompt text.
Output: A complete prompt sentence that encodes statistical trends and, optionally, emotional context, ready to be input to the generative AI model.

### Step 9:

The server transmits the prompt sentence to a generative AI model and controls text generation.
Input: The prompt sentence from Step 8 and configuration parameters for the generative AI model, such as maximum length and decoding strategy.
The server encodes the prompt sentence into tokens using a tokenizer corresponding to the generative AI model's vocabulary. The server sends the token sequence and configuration parameters to the generative AI model, which may reside on an external service or an internal accelerator. The server receives token-by-token output from the generative AI model and optionally applies constraints during decoding, such as filtering out invalid time expressions or forbidden phrases. The server reconstructs the full generated text from the output tokens.
Output: A raw generated text representing operation proposal information with recommendations on distribution time and distribution content.

### Step 10:

The server post-processes and validates the operation proposal information.
Input: The raw generated text from Step 9.
The server parses the generated text to extract structured elements such as recommended weekdays, time ranges, content themes, and headline styles, using pattern matching or natural language parsing rules. The server checks each extracted element against system constraints, for example verifying that recommended time slots do not conflict with blackout periods. When invalid or ambiguous segments are detected, the server can either correct them using deterministic rules or discard them. The server then reassembles a coherent, formatted proposal text that only includes validated recommendations and aligns the structured elements with the natural language text.
Output: A validated and formatted operation proposal text and, optionally, a structured representation of the same proposal.

### Step 11:

The server prepares notification data and delivers the operation proposal to the terminal.
Input: The validated operation proposal text from Step 10 and user or device identifiers stored in the system.
The server constructs a notification payload that contains a concise summary of the operation proposal, such as “New recommended distribution time: Wednesday 18:00-20:00,” along with a reference identifier for retrieving the full proposal. The server interacts with a push notification service or an internal messaging interface to address the payload to the appropriate terminal. The server logs the delivery attempt and stores the full proposal text in association with the reference identifier.
Output: Notification data transmitted over the network to the terminal and stored proposal data retrievable by identifier.

### Step 12:

The terminal receives and displays the operation proposal information to the user.
Input: The notification data sent from the server in Step 11.
The terminal's communication module receives the notification and invokes an application component that handles proposal notifications. The terminal presents a summary message in a notification area or within the application interface. When the user interacts with the notification, the terminal sends a request to the server including the reference identifier. The terminal receives the full operation proposal text in response and renders it on a display, organizing the content into readable sections.
Output: A user interface screen on the terminal that visibly presents the operation proposal information to the user.

### Step 13:

The user reviews and utilizes the operation proposal information.
Input: The displayed proposal screen on the terminal from Step 12.
The user reads the recommended distribution times, content topics, and sample headlines. The user may accept some recommendations by activating corresponding controls on the terminal, such as buttons for “apply schedule” or “use headline template.” The user may also provide feedback on the usefulness of the proposal via selectable options. The terminal transmits these user selections and feedback to the server, where they can be logged and used as additional data for refining threshold settings, aggregation rules, or future model training.
   Output: User actions and feedback data that can be stored by the server for subsequent analysis and potential adaptation of future operation proposals.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information delivery systems that utilize machine learning and content recommendation techniques typically determine what information to send to a user by applying static ranking algorithms or rule-based filters to user logs. However, such systems exhibit several technical limitations from the standpoint of computer technology.

First, known systems generally treat user behavior logs, such as message views, link clicks, and user reactions, as simple counters or coarse-grained statistics, and do not convert these logs into structured user profiles that can be directly and dynamically consumed by a generative AI model. As a result, the interface between the profiling component and the content generation component is loosely coupled and semantically shallow. This leads to an inefficient use of computational resources, because the generative AI model is often invoked with generic, non-specific prompts that fail to exploit the rich behavior data already processed by the server.

Second, many existing architectures perform content recommendation and content generation as independent pipelines. Recommendation engines output a list of items based on historical data, whereas text generation engines receive minimal context and generate summaries or messages that are not precisely tuned to fine-grained user preferences. This architectural decoupling causes redundant computation, increased network traffic, and additional latency, because the server cannot systematically feed reaction signals back into both the recommendation logic and the prompt construction logic in a unified manner.

Third, even when user feedback, such as positive or negative reactions, is collected, conventional systems often use such feedback only for coarse re-ranking or offline model retraining. They do not transform feedback into quantitative indices that are immediately reflected not only in the user profile but also in the generation rules of the prompt sentences. Consequently, the system has limited capability to adaptively adjust the behavior of the generative AI model at runtime for each individual user, and struggles to maintain both high personalization accuracy and efficient use of computational resources.

Fourth, typical systems do not specify, at the protocol or data-structure level, how to systematically generate prompt sentences that encode constraints such as summary length, language, difficulty level, and emphasis on particular subjects, in direct response to observed user behavior. Without a well-defined, machine-implemented mechanism that continuously updates these constraints based on structured feedback, the generative AI model cannot be effectively controlled and tends to produce outputs that are either unnecessarily long, too technical, or misaligned with the user's demonstrated preferences, thereby degrading the overall throughput and response quality of the server.

Accordingly, there is a need for an improved computer-implemented system that: (i) acquires and structures user history information and reaction information into a dynamic user profile; (ii) uses that profile to select candidate content; (iii) constructs, in an automated and adaptive manner, prompt sentences for a generative AI model that encode user-specific constraints; and (iv) feeds back quantitative indices derived from reaction logs into both the user profile and the prompt generation rules. Such a system should enhance the efficiency, accuracy, and adaptability of information delivery at the level of server-side computation, thereby improving the operation of the computer system itself rather than merely automating a human mental process.

The specific processing by the specific processing unit 290 of the data processing device 12 in Application Example 1 is realized by the following means.

The present invention provides a server comprising a processor and a storage unit, the processor being configured to execute instructions that cause the server to acquire user history information via a messaging communication interface and store the user history information in the storage unit; analyze the stored user history information using a statistical method and a machine learning method to generate, for each user, a user profile indicating an interest tendency and a behavioral characteristic, and to select delivery candidate information on the basis of the user profile; construct a prompt sentence, on the basis of the user profile and a content of the delivery candidate information, the prompt sentence including an instruction sentence that explicitly specifies at least a summary length, a language, a difficulty level of expression, and a subject to be emphasized, and being configured to instruct a generative AI model to generate summary information and proposal information; input the prompt sentence into the generative AI model and obtain the summary information and the proposal information from the generative AI model; transmit delivery information including the obtained summary information and the proposal information to a user terminal via the messaging communication interface; acquire reaction information to the delivery information from the user terminal, the reaction information including behavior log information representing at least a viewing state, a selection operation, an evaluation operation, and a response text; convert the reaction information into one or more quantitative indices including at least a preference index for each topic and an effectiveness index for each delivery condition; and update both the user profile and a generation rule of the prompt sentence on the basis of the quantitative indices so as to sequentially optimize a generation process of the summary information and the proposal information by the generative AI model. This enables the server to implement an integrated, computer-implemented feedback loop in which user history information and reaction information are transformed into structured profiles and quantitative indices that directly control both content selection and prompt construction, thereby improving computational efficiency, reducing unnecessary generative processing, and enhancing the personalization accuracy and responsiveness of the information delivery system as a whole.

The term “user history information” refers to machine-readable data representing past interactions of a user with a messaging communication interface, including at least message viewing states, link selections, evaluation operations, and response texts, each associated with a user identifier and time information.

The term “messaging communication interface” refers to a hardware and software interface that enables exchange of digital messages between a server and a user terminal, and that exposes an application programming interface for sending messages to and receiving messages from the user terminal.

The term “storage unit” refers to a computer-readable memory device or memory subsystem, such as a volatile memory or a non-volatile memory, that is configured to store user history information, user profiles, delivery candidate information, prompt sentences, and reaction information in association with identifiers.

The term “statistical method” refers to a computer-implemented procedure that uses statistical analysis, such as aggregation, averaging, distribution estimation, or correlation analysis, to derive numerical characteristics from user history information.

The term “machine learning method” refers to a computer-implemented algorithm that automatically learns parameters from data, such as a classification algorithm, a clustering algorithm, or a regression algorithm, in order to infer user interest tendencies or behavioral characteristics from user history information.

The term “user profile” refers to a data structure stored in the storage unit that represents, for each user, at least an interest tendency and a behavioral characteristic, and that is updated on the basis of user history information and reaction information.

The term “interest tendency” refers to a set of one or more numerical values or categorical indicators within the user profile that represent degrees of preference of the user for respective topics, content types, or subject areas.

The term “behavioral characteristic” refers to a parameter within the user profile that represents a pattern of user actions over time, including at least preferred information amount, preferred expression style, typical viewing time, or responsiveness to delivered information.

The term “delivery candidate information” refers to digital content items, such as text information, image information, or link information, that are selected by the processor as candidates for transmission to a user terminal on the basis of the user profile.

The term “prompt sentence” refers to a machine-readable textual instruction generated by the processor for input to a generative AI model, the instruction specifying at least a context, a desired output type, and one or more constraints such as summary length, language, difficulty level of expression, and subject to be emphasized.

The term “instruction sentence” refers to a part of the prompt sentence that explicitly describes operational constraints or requirements to be followed by the generative AI model, including at least a required summary length, a required language, a required difficulty level of expression, and a subject to be emphasized.

The term “generative AI model” refers to a machine learning model implemented by a computing system that is configured to generate new text or other content in response to an input prompt sentence, based on parameters learned from training data.

The term “summary information” refers to text data generated by the generative AI model in response to the prompt sentence, the text data being shorter than the original content and expressing essential points of the delivery candidate information.

The term “proposal information” refers to text data generated by the generative AI model in response to the prompt sentence, the text data including at least a suggestion, recommendation, or call-to-action tailored to the user profile.

The term “delivery information” refers to a message payload generated by the processor for transmission to a user terminal via the messaging communication interface, the payload including at least the summary information and the proposal information and optionally including identifiers, links, or metadata.

The term “user terminal” refers to an electronic device operated by a user, such as a mobile communication device, a tablet device, or a personal computer, that is configured to communicate with the server via the messaging communication interface and to present delivery information to the user.

The term “reaction information” refers to machine-readable data indicating a response of the user to delivery information, including at least behavior log information such as a viewing state, a selection operation, an evaluation operation, and a response text.

The term “behavior log information” refers to time-stamped records representing user actions in relation to delivered information, including at least whether the delivered information was viewed, whether a link was selected, whether an evaluation operation was performed, and what response text was sent.

The term “quantitative index” refers to a numerical value calculated by the processor from reaction information or behavior log information, and used to measure at least a preference of the user for a topic or an effectiveness of a delivery condition.

The term “preference index” refers to a quantitative index that indicates a degree of preference of the user for a particular topic, subject, or content type, calculated on the basis of reaction information corresponding to delivery information relating to that topic.

The term “effectiveness index” refers to a quantitative index that indicates a degree of effectiveness of a particular delivery condition, such as delivery timing, summary length, or expression style, calculated on the basis of reaction information associated with delivery information delivered under that condition.

The term “generation rule of the prompt sentence” refers to a set of parameters or logical conditions used by the processor to determine how to construct the prompt sentence, including at least rules for selecting constraints on summary length, language, difficulty level of expression, and subject to be emphasized based on contents of the user profile and quantitative indices.

The term “sequentially optimize” refers to a process in which the processor repeatedly updates the user profile and the generation rule of the prompt sentence in response to newly acquired reaction information so that subsequent generation processes by the generative AI model are progressively improved over time.

In one embodiment, a server operates as a network-connected information processing apparatus that implements the claimed system. The server includes at least one processor, a main memory, a non-volatile storage device such as a solid-state drive, and a network interface. The server executes an operating system, such as a general-purpose server operating system, and an application stack including a web server, an application server, and a database management system, such as a relational database system. The server further communicates with one or more terminals operated by users, such as smartphones, tablet computers, or personal computers, each executing a messaging application that exposes an application programming interface for exchanging message data with the server.

The server uses the messaging application programming interface to acquire user history information. The server receives, from the messaging platform, event data including message delivery events, message read receipts, link click events, button press events, and user reply messages. The server parses event payloads expressed in a structured message format, extracts a user identifier, a delivery identifier, a timestamp, a message type identifier, and textual content where present, and writes these values as records to a user history table in the relational database or to a data warehouse system, such as a distributed columnar datastore. The server thereby maintains a structured log of user behavior, indexed by user identifiers and time.

The server performs data processing on the stored user history information using a data analysis module implemented in a general-purpose programming language such as Python or Java. The server invokes a statistical library to compute aggregate statistics, such as counts of events per topic category, average dwell time per delivered content item, and distribution of reactions for each type of message. The server also invokes a machine learning library, for example a library providing vectorization, clustering, and classification algorithms, to derive a user profile for each user. The user profile is stored as a structured record including fields representing topic preference scores, content length preferences, preferred language or style, and responsiveness indicators.

The server converts textual components of the user history information, such as titles of consumed content and user reply messages, into numerical feature vectors. The server uses a tokenizer to split text into tokens, removes stop-words using a predefined list, and applies a term weighting scheme, such as term frequency-inverse document frequency, to obtain a sparse representation of each text item. The server optionally uses a neural embedding model, such as a model based on a transformer encoder architecture trained on large-scale text corpora, to obtain dense embedding vectors for text segments. The server then aggregates text vectors for each user, for example by computing a weighted average that assigns higher weights to text items for which the user exhibited longer dwell times or positive reactions. This aggregation produces a compact representation of user interests that can be processed efficiently by subsequent algorithms.

The server applies a clustering algorithm, such as k-means clustering implemented in a machine learning library, to the aggregated user vectors to assign each user to one or more clusters representing thematic interest groups. The server also applies a classification algorithm, such as logistic regression or gradient-boosted decision trees, trained on labeled content categories, to predict topic preference scores for each user across multiple topics. The server writes the resulting cluster identifiers, topic scores, and behavioral attributes as fields of the user profile. By representing user interests in a machine-readable numerical form, the server reduces the need to reprocess raw logs for each request, thereby improving memory locality and reducing CPU load during subsequent retrieval and matching operations.

The server retrieves delivery candidate information from one or more content sources. The server connects to a content repository, such as a content management system backed by a relational database, or an external content feed exposed through a web application programming interface. The server executes structured queries specifying topic filters, publication time windows, and quality indicators such as editorial scores or prior global engagement metrics. For each candidate content item, the server retrieves metadata including a content identifier, a title, a category label, a publication date, and a body text. The server may precompute a content vector for each item by applying the same text vectorization and embedding procedures used for user history information.

The server matches user profiles with delivery candidate information using a numerical relevance computation. The server computes a similarity measure between the user's interest vector and the content vector for each candidate item, for example by computing a cosine similarity between the two vectors. The server then modifies the similarity score using additional factors, such as a recency weight based on the publication date and a diversification penalty to avoid repeatedly delivering similar content. The server ranks candidate items according to the final score and selects one or more top-ranked items as delivery candidate information for that user. This numerical matching reduces unnecessary data transmission by ensuring that only high-relevance items are passed forward to the generative AI model, thereby lowering network and computation loads.

The server constructs a prompt sentence to be supplied to a generative AI model. The server uses the user profile and the content of the selected delivery candidate information to determine constraints for the prompt sentence. The server reads the user's preferred summary length from the user profile, selects a language field, determines an appropriate difficulty level of expression based on past feedback, and identifies one or more subjects to be emphasized according to the user's highest topic scores. The server then generates a textual instruction that explicitly encodes these constraints in natural language. The server appends the content title and a body text or a representative excerpt to the instruction, clearly separating the instruction portion from the content portion with delimiters. The result is a prompt sentence that encodes both user-specific constraints and the input content to be summarized.

In one example, the server generates the following prompt sentence:
“The user frequently reads articles about artificial intelligence and cloud computing and has indicated that overly technical content is ‘too difficult’. Read the following technology article and generate a summary in English that is easy for a non-engineer to understand.
Requirements:
Length: about 120 words.
Focus: explain the main AI-related points and how they affect cloud services.
Style: clear, non-technical, and suitable for delivery via a mobile messaging app.
---ARTICLE START---
[full article text here]
---ARTICLE END---”

In another example, the server generates the following prompt sentence:
“Based on the user's past viewing history, please summarize the next technology-related article to be delivered. The user prefers concise explanations and key takeaways. Provide the summary in English within 150 words.”

The server transmits the constructed prompt sentence to a generative AI model. The generative AI model may be implemented as a deep neural network including an encoder-decoder or decoder-only transformer architecture, having multiple attention layers, feed-forward layers, and layer normalization modules. The model parameters, such as attention weights and feed-forward weights, are stored in memory units on a specialized computing cluster. During inference, the server sends the prompt sentence through a network interface using a request protocol to a model-serving endpoint. The model-serving system converts the textual prompt into token identifiers, applies embedding layers and positional encodings, and then performs a series of matrix multiplications and non-linear transformations according to the transformer architecture. The model generates an output sequence of tokens representing the summary information and proposal information, guided by the constraints expressed in the prompt sentence and by learned probability distributions over token sequences.

The server receives the generated text from the generative AI model and performs validation and post-processing. The server verifies that the generated text satisfies basic constraints, such as being within the expected length range and in the requested language. The server may apply a simple syntactic check to confirm that the output includes at least one complete sentence and does not include forbidden terms or structures. The server can also truncate or lightly reformat the output, for example by converting a long paragraph into shorter paragraphs to match the messaging application's display constraints. By performing this validation and reformatting, the server reduces the probability of malformed outputs and ensures efficient rendering on the terminal.

The server assembles delivery information by combining the validated summary information and proposal information with metadata such as the content identifier and a destination link. The server creates a message payload formatted according to the specifications of the messaging communication interface, including fields for text content, optional image information, and user interface components such as buttons. The server associates a delivery identifier with the message and stores a record including the user identifier, delivery identifier, content identifier, and a copy of the generated text in the database. The server then transmits the delivery information to the terminal via the messaging communication interface. The terminal, which may be implemented as a smartphone running a messaging application, receives the delivery information through the messaging platform's push mechanism. The terminal stores the message in a local message cache and renders the text, buttons, and links on a display. The user reads the summary information and proposal information and may interact with the message by tapping a link, pressing a feedback button, or sending a reply. The terminal captures these operations and transmits corresponding events back to the server via the messaging communication interface.

The server receives reaction information from the terminal in the form of interaction events. The server parses event payloads to extract the user identifier, delivery identifier, reaction type (for example, click, positive feedback, negative feedback), and optional text contained in user replies. The server writes logged events to a reaction log table, associating each event with the corresponding delivery information record. The server then converts raw reaction events into quantitative indices. For example, the server defines a preference index for each topic as a function of the number of positive and negative reactions to content items associated with that topic. The server also defines an effectiveness index for each delivery condition, such as summary length or delivery time window, based on the click-through rate and dwell time for messages delivered under those conditions.

The server updates the user profile by adjusting topic preference scores and behavioral characteristics using the quantitative indices. The server may apply an exponential moving average update rule, in which a new preference score is computed as a weighted combination of the existing score and a score derived from recent reactions, with a smoothing parameter controlling sensitivity to recent data. The server also updates the generation rule of the prompt sentence by adjusting parameters such as the default summary length, preferred difficulty level, and emphasis subjects for that user. For example, if the preference index for shorter summaries increases, the server reduces the target word count in future prompt sentences. If the effectiveness index indicates higher engagement for non-technical language, the server modifies the instruction sentence to request simpler expressions.

The server thereby implements a feedback loop in which reaction information directly influences both user profile values and prompt generation behavior. This feedback loop yields technical effects at the computer system level. Because the server constructs prompt sentences that encode user-specific constraints derived from structured quantitative indices, the generative AI model is less likely to produce irrelevant or excessively long outputs. This reduces the average number of model invocations required to obtain acceptable summaries, thereby decreasing processing latency and computational load on the model-serving infrastructure. Additionally, by updating profiles and prompt generation rules incrementally, the server avoids repeatedly performing full retraining of large models, leading to improved resource utilization and more efficient use of memory and processor cycles.

The server can employ a particular training method for the generative AI model in certain embodiments. During model training, a training dataset comprising pairs of input articles and target summaries, annotated with style and length attributes, is used. The server or a training subsystem computes a loss function based on a cross-entropy error between generated token distributions and target summaries, with additional penalties for deviations from desired length or style attributes. The training process updates model weights using a gradient-based optimizer, such as stochastic gradient descent with momentum or an adaptive learning rate algorithm. Data augmentation techniques, such as random paraphrasing or truncation of source texts, may be applied to improve robustness to varied prompt sentence formulations. Although training may be performed offline, the described structure and usage of user-specific prompt sentences at inference time yields an improved mapping between user constraints and generated content.

In another embodiment, the server uses a hybrid architecture in which a smaller, locally hosted neural model performs a preliminary generation or rewriting step, and a larger, remote generative AI model performs a final refinement step only when necessary. In this case, the server decides, based on the effectiveness index and an internal quality prediction score, whether the locally generated summary is sufficient. If the predicted quality exceeds a threshold, the server directly uses the local result, thereby avoiding a remote call and reducing network traffic. If not, the server forwards a refined prompt sentence including the preliminary summary and explicit correction instructions to the remote generative AI model. This architecture further reduces network load and average response time while maintaining high personalization and quality.

In yet another embodiment, the server partitions user profiles and reaction log data across multiple database shards. The server uses a consistent hashing scheme to assign user identifiers to shards, thereby balancing load. The server performs vectorization and clustering operations on batches of users within each shard using distributed processing frameworks, such as a batch processing engine. By organizing the data pipeline in this fashion, the server improves cache locality and reduces inter-node communication overhead during feature computation and clustering, which further improves processing throughput and scalability. The technical effects of the described system arise from specific interactions between data structures, algorithms, and computational components. By representing user interests and behaviors as numerical vectors and indices, by using these values both for content selection and for constrained prompt sentence construction, and by updating them through a structured feedback loop, the server improves the efficiency and accuracy of generative content delivery beyond what can be achieved by simple rule-based automation. The server reduces redundant generative processing, tailors computational effort to the most relevant content-user pairs, and minimizes unnecessary data transmission. These improvements are realized within the computer system and its communication with terminals, and are not merely an automation of human decision-making.

The terminal, in each embodiment, continues to operate as a presentation and interaction device, rendering messages provided by the server and transmitting user operations back to the server. The user interacts with the displayed summary information and proposal information, providing feedback implicitly through behavior and explicitly through evaluation operations. The server collects and integrates these signals in a form that a human operator could not process in real time or at such scale, thereby enabling improved use of computing resources and providing a technical solution to the problem of efficiently generating and delivering highly personalized information using a generative AI model and a dynamically constructed prompt sentence.

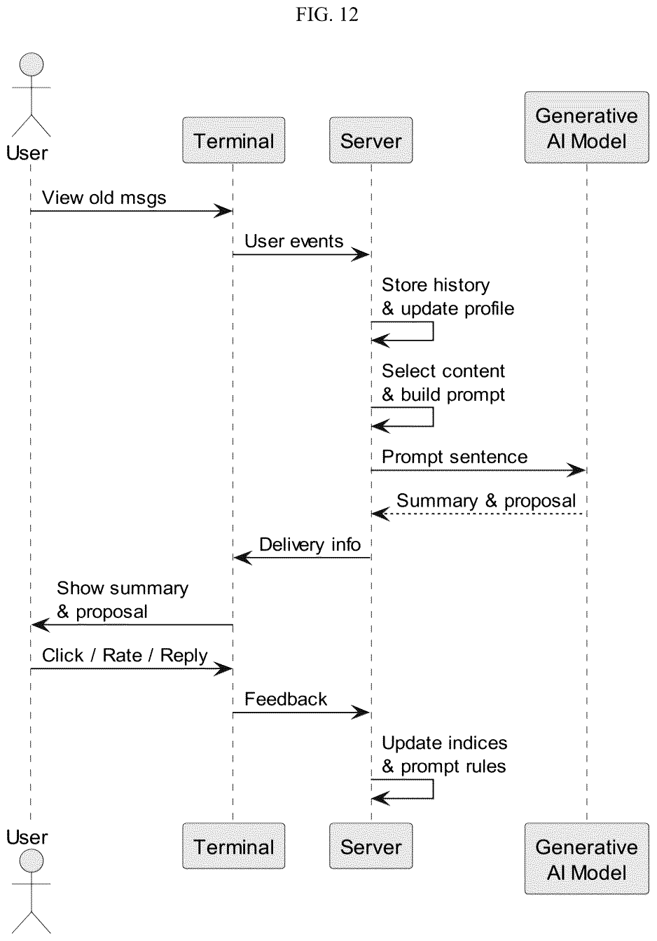

The following describes the processing flow using FIG. 12.

### Step 1:

The server acquires user history information via a messaging communication interface.
The input is event data generated by a messaging platform, including message delivery events, read receipts, button clicks, link clicks, and user reply messages.
The server parses each event payload, extracts a user identifier, a delivery identifier, a timestamp, an event type, and any text content, and normalizes these values into a unified record format.
The server writes the normalized records into a user history table in a database or into a log storage system, thereby producing stored user history information as the output.

### Step 2:

The server aggregates and structures the stored user history information.
The input is the set of event records stored in the user history table for each user over a given time window.
The server groups records by user identifier, sorts them chronologically, and computes aggregate values such as the number of messages delivered, the number of messages opened, the number of link clicks per topic, and the average time between delivery and first interaction.
The server stores these aggregate values and ordered sequences as an intermediate user behavior dataset, which becomes the output of this step.

### Step 3:

The server preprocesses textual data contained in the user behavior dataset.
The input is text fields such as article titles, article snippets, and user reply messages associated with the user behavior dataset.
The server applies tokenization, lowercasing, stop-word removal, and optional stemming or lemmatization to each text field, then converts the cleaned tokens into numerical term-frequency or term frequency-inverse document frequency vectors.
The server outputs a preprocessed text dataset in which each text entry is associated with a numerical feature vector and a user identifier.

### Step 4:

The server extracts user interest features using a machine learning method.
The input is the preprocessed text dataset and associated engagement metrics (such as dwell time and reaction labels).
The server weights each text feature vector according to engagement metrics, for example by multiplying vector components by a dwell-time-based weight, and then computes a user-level interest vector by averaging or summing the weighted vectors for each user.
The server writes the user-level interest vectors into a feature store as user interest feature records, which serve as the output for this step.

### Step 5:

The server generates and updates a user profile for each user.
The input is the user interest feature records and the aggregated behavioral metrics from Step 2.
The server applies a clustering algorithm (such as k-means) to the interest vectors to assign cluster identifiers, and applies a classification or regression algorithm to produce topic scores, preferred content length scores, and responsiveness indicators.
The server combines these results into a structured user profile record including cluster identifiers, topic preference scores, preferred summary length, language preference, and expression difficulty preference, and stores this record in a profile table as the output.

### Step 6:

The server retrieves delivery candidate information from one or more content sources.
The input is the current user profile record and content metadata stored in a content repository.
The server generates a query that filters content by topic category, recency, and quality metrics, then executes the query on a content database or via a content API to obtain candidate content items.
The server outputs a candidate content set for the user, each item including a content identifier, title, body text, category labels, and publication time.

### Step 7:

The server computes relevance scores between the user profile and the candidate content set.
The input is the user profile (including a user interest vector) and numerical vectors for each candidate content item.
The server calculates a similarity measure, such as cosine similarity, between the user interest vector and each content vector, and adjusts this similarity using recency weights and diversity penalties to avoid repetition.
The server ranks candidate content items by their final relevance scores and outputs a small subset of top-ranked items as selected delivery candidate information.

### Step 8:

The server determines prompt constraints based on the user profile and the selected delivery candidate information.
The input is the user profile record and the metadata of the selected content items (such as topic labels and length of the body text).
The server reads the preferred summary length, language, and difficulty level from the user profile, identifies the main topics to emphasize from the highest topic scores, and decides explicit constraint values (for example, “about 120 words”, “English”, “non-technical style”, “emphasize AI-related aspects”).
The server outputs a set of constraint parameters to be embedded into a prompt sentence.

### Step 9:

The server constructs a prompt sentence for a generative AI model.
The input is the selected delivery candidate content (title and body text) and the constraint parameters from Step 8.
The server generates a natural-language instruction part that explicitly states the summary length, language, difficulty level, and subjects to emphasize, then appends the content title and body text enclosed within delimiters such as “---ARTICLE START---” and “---ARTICLE END---”.
The server outputs a complete prompt sentence string configured to instruct the generative AI model to generate summary information and proposal information.

### Step 10:

The server transmits the prompt sentence to the generative AI model and obtains generated text.
The input is the prompt sentence string and model invocation parameters such as maximum token count and sampling settings.
The server sends a request through a network interface to a model-serving endpoint, which tokenizes the prompt, processes it through a neural network (for example, a transformer-based decoder with multiple attention layers and learned parameters), and returns a sequence of output tokens.
The server decodes the tokens into text to obtain summary information and proposal information, and stores these texts as the output of this step.

### Step 11:

The server validates and post-processes the summary information and proposal information.
The input is the raw generated summary text and proposal text produced in Step 10.
The server checks the length, language, and basic syntactic completeness of the generated text, optionally applies rule-based filters to remove disallowed phrases, and may adjust formatting by inserting line breaks or bullet markers according to messaging display constraints.
The server outputs validated and formatted summary information and proposal information suitable for delivery to the terminal.

### Step 12:

The server assembles delivery information and transmits it to the terminal.
The input is the validated summary information and proposal information, together with the content identifier, user identifier, and optional resource links or thumbnails.
The server creates a message payload for the messaging communication interface, embeds the textual content and metadata, assigns a delivery identifier, stores a record of the outgoing message, and sends the payload to the messaging platform for forwarding.
The server outputs a delivered message instance that is transmitted over the network and received by the terminal.

### Step 13:

The terminal receives and presents the delivery information to the user.
The input is the message payload delivered via the messaging communication interface.
The terminal stores the payload in a local message store, extracts the text and visual elements, and renders the summary and proposal on a display with interactive components such as buttons or links.
The terminal outputs a visual presentation on the screen that the user can read and interact with.

### Step 14:

The user interacts with the delivered information and provides reactions.
The input is the summary information and proposal information displayed on the terminal screen.
The user reads the content, and may tap a link, press a positive or negative feedback button, or type a reply message expressing subjective evaluation or questions.
The user's interactions result in reaction events (clicks, ratings, reply texts) that are captured by the terminal and prepared for transmission as the output.

### Step 15:

The terminal sends reaction information to the server.
The input is the user's interaction events, including button presses, link clicks, and reply texts associated with the displayed message.
The terminal packages these events into event messages containing at least a user identifier, delivery identifier, reaction type, and optional text, and transmits them via the messaging communication interface back to the server.
The terminal outputs structured reaction information messages that serve as input to server-side feedback processing.

### Step 16:

The server logs and parses the reaction information.
The input is the reaction information messages received from the terminal.
The server extracts identifiers, reaction types, timestamps, and text content, links each reaction to the corresponding delivered message via the delivery identifier, and stores reaction records in a reaction log table or data store.
The server outputs a structured reaction dataset that associates each user reaction with specific delivery information and content topics.

### Step 17:

The server converts reaction information into quantitative indices.
The input is the structured reaction dataset containing events such as views, clicks, positive ratings, negative ratings, and reply texts.
The server assigns numerical values to different reaction types (for example, click=+1, positive feedback=+2, negative feedback=−2), computes normalized metrics such as click-through rate and dwell time for each topic and delivery condition, and aggregates these metrics into preference indices and effectiveness indices.
The server outputs updated quantitative indices for each user-topic pair and for each delivery condition.

### Step 18:

The server updates the user profile and the generation rule of the prompt sentence.
The input is the current user profile and the newly computed quantitative indices from Step 17.
The server adjusts topic preference scores in the user profile using an update rule, such as an exponential moving average, updates behavioral characteristics such as preferred summary length and difficulty level based on the effectiveness indices, and modifies rule parameters that control how future prompt sentences will specify constraints.
The server outputs an updated user profile and an updated set of prompt generation rules, which are then used as inputs to subsequent executions of Steps 6 through 11, thereby adaptively improving the behavior of the generative AI model and the personalization quality over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information distribution systems that operate over information communication applications typically rely on static rules, manually designed schedules, and heuristic targeting strategies. In many implementations, a server simply records message transmission logs and basic reaction data such as opens and clicks, and then human operators manually export such data, perform ad-hoc analysis with external tools, and heuristically design future campaigns. This workflow is inherently fragmented and inefficient, and prevents the server from automatically optimizing distribution strategies in a closed loop manner.

Furthermore, in many existing systems, any use of machine learning or statistical analysis is limited to offline reporting. The server may calculate overall open rates and click-through rates, but it does not structurally transform these results into machine-consumable input for a generative AI model. As a consequence, the system cannot automatically generate detailed operational proposals, such as concrete distribution times, target user groups, and message contents, that are tailored to the actual performance data accumulated in the system. The lack of a standardized mechanism for constructing prompt sentences from structured performance metrics prevents the generative AI model from being tightly integrated into the core control flow of the distribution server.

Additionally, conventional architectures do not integrate emotional state analysis of message content with performance indices in a systematic way. Even when text analysis is applied, the emotional characteristics of messages and their quantitative impact on open and click behaviors are not stored or reused as structured features. As a result, the server cannot exploit relationships between emotional tone, distribution conditions, and user reactions when generating new proposals. This leads to underutilization of available computing resources and data, and fails to improve the underlying computer technology for campaign optimization.

From the perspective of computer technology, there is a need for a server-centered architecture in which: (i) communication history data and reaction data are continuously acquired and normalized in a machine-processable form; (ii) statistical and machine learning analysis is executed on the server to derive high-performance distribution conditions and associated performance indices; (iii) these analysis results, including emotional state information, are automatically converted into structured prompt sentences suitable for a generative AI model; and (iv) the output of the generative AI model is fed back into the server as executable distribution plan information that directly controls subsequent message distribution. Without such an integrated, iterative mechanism, the server cannot effectively improve throughput, reduce operator workload, and enhance accuracy and adaptability of distribution strategies in a repeatable and scalable manner.

The specific processing by the specific processing unit 290 of the data processing device 12 in Example 2 is realized by the following means.

The present invention provides a server comprising a processor configured to acquire, via a communication interface of an information communication application over a network, communication history data and reaction data associated with users, to store the acquired data in a structured data storage, to classify the stored data based on at least one criterion including a time slot, a user attribute, and a distribution content, to calculate performance indices relating to open rates and click-through rates by applying statistical processing and machine learning processing to the classified data, and to identify high-performance distribution conditions as analysis results; the processor further being configured to generate text data including the identified high-performance distribution conditions and summary information derived from the analysis results, to construct a prompt sentence for input to a generative AI model based on the text data, to input the constructed prompt sentence and, optionally, information representing a quantified emotional state into the generative AI model, to obtain from the generative AI model operation proposal information specifying at least a distribution time, a target user group, and a message content adjusted according to a combination of the emotional state, the distribution conditions, and the performance indices, and to generate executable distribution plan information based on the operation proposal information, to execute a message distribution process through the communication interface of the information communication application in accordance with the distribution plan information, and to store, as new communication history data and reaction data, results of the message distribution process in the data storage for use in subsequent iterations of analysis and proposal generation. This enables a closed-loop, server-driven optimization process in which the server itself improves computer-implemented distribution control by automatically transforming accumulated performance data into machine-interpretable prompt sentences for a generative AI model, by integrating emotional state analysis with distribution metrics, and by directly converting AI-generated proposals into executable distribution plans, thereby enhancing processing efficiency, scalability, and accuracy of message distribution operations beyond manually tuned or statically configured systems.

The term “information communication application” refers to a software platform or service that enables users to transmit and receive digital messages or content over a communication network.

The term “communication interface” refers to an application programming interface or other machine-readable interface through which a server exchanges requests and responses with an information communication application.

The term “communication history data” refers to data records indicating transmission and reception events of messages, including at least identifiers, timestamps, and association with users.

The term “reaction data” refers to data records indicating user responses to messages, including at least open events, click events, or other interaction events associated with the messages.

The term “data storage” refers to a hardware and software combination configured to store, retrieve, and manage structured data, including at least a database system or a persistent storage medium.

The term “time slot” refers to a temporal interval defined based on a clock time or calendar time and used as a unit for classifying communication history data and reaction data.

The term “user attribute” refers to information that characterizes a user, including at least demographic information, geographic information, or behavioral information.

The term “distribution content” refers to information contained in a message to be delivered, including at least a subject, a body text, or associated metadata defining the content of the message.

The term “performance index” refers to a numerical value computed from communication history data and reaction data to evaluate performance of message distribution, including at least an open rate or a click-through rate.

The term “statistical processing” refers to processing that applies statistical methods, such as aggregation, grouping, or correlation analysis, to compute performance indices from stored data.

The term “machine learning processing” refers to processing that applies an algorithm that learns a relationship between input variables and output variables from data, and that is used to estimate or predict performance indices or distribution conditions.

The term “high-performance distribution condition” refers to a set of distribution parameters, including at least a time slot, a user attribute condition, or a distribution content characteristic, that yields performance indices satisfying a predetermined criterion.

The term “text data” refers to character-based data representing information in a natural language form that can be processed by a generative AI model.

The term “prompt sentence” refers to text data formatted as an instruction or query, including at least analysis results and constraints, which is provided as an input to a generative AI model to cause the model to generate output.

The term “generative AI model” refers to an information processing model implemented by software and hardware that generates text or other data based on a given input sequence, using a learned probabilistic or neural network-based representation.

The term “operation proposal information” refers to information generated by the generative AI model that specifies recommended parameters for operating a message distribution process, including at least a distribution time, a target user group, or a message content.

The term “distribution plan information” refers to structured control data derived from operation proposal information, defining concrete settings for executing a message distribution process, including at least scheduling information and target selection conditions.

The term “message distribution process” refers to a sequence of processing steps executed by a server to transmit messages to users via an information communication application according to distribution plan information.

The term “emotional state” refers to an affective characteristic inferred from a message content, such as positivity, negativity, or specific emotions, represented in a form suitable for quantitative processing.

The term “emotion analysis technique” refers to a computational method, including at least text mining or natural language processing, configured to estimate or classify an emotional state from a message content.

The term “quantified emotional state” refers to an emotional state represented as a numerical value or a structured label that can be processed together with performance indices and distribution conditions.

In one embodiment, a server is implemented as an electronic computer system including at least one central processing unit (CPU), a main memory, a non-volatile storage device, and a network interface. The server is connected via a communication network to a plurality of terminals operated by users, and to an information communication application executed on one or more remote computing systems. The information communication application exposes a communication interface, such as a REST-type application programming interface, through which the server exchanges request and response messages.

The server uses the network interface and a communication library, such as an HTTP client library, to request communication history data and reaction data from the information communication application. The communication history data includes message identifiers, user identifiers, transmission timestamps, message categories, and channel information. The reaction data includes at least open events, click events, and optionally other interaction events, each associated with a message identifier and a user identifier. The server receives the data in a structured format such as JavaScript Object Notation and parses the data using a parser module executing on the CPU.

The server stores the parsed communication history data and reaction data in a data storage implemented as a relational database management system, such as a structured query language database running on the same machine or on a separate storage server. The server defines normalized tables for messages, user profiles, open events, click events, and campaigns. Each table includes indexed columns for message identifiers, user identifiers, timestamps, and attributes. The server inserts new records and updates existing records using transactional operations so that the data storage always maintains a consistent state. Because the tables are normalized and indexed, the server can efficiently retrieve and aggregate large volumes of historical data, thereby improving data access latency and reducing processing time compared to ad-hoc file-based storage.

The server uses a data analysis environment executed on the same processor or on a cooperating processor, for example a runtime environment for a general-purpose programming language. The server loads subsets of the stored data into an in-memory data structure such as a tabular data structure. The server then performs statistical processing and machine learning processing on these data structures to compute performance indices. Specifically, the server groups records by time slot, user attribute, and distribution content category, and calculates metrics such as total sends, total opens, total clicks, open rates, and click-through rates. The server further calculates confidence measures and variance values to assess the reliability of the performance indices.

The server optionally applies a machine learning model, such as a logistic regression model, a gradient-boosted decision tree model, or a neural network model, to learn relationships between input features and reaction outcomes. The server defines input features including time slot encoding, day-of-week encoding, user demographic attributes, device type, and content category identifiers. The server defines target variables such as open probability and click probability. The server trains the model by minimizing a loss function, such as a cross-entropy loss, using an optimization algorithm, such as stochastic gradient descent or a variant of a quasi-Newton method. The server stores learned parameters, such as weight vectors for logistic regression or node split thresholds for tree-based models, in the data storage.

In an embodiment using a neural network model as part of the analysis, the server implements a feed-forward architecture having an input layer corresponding to encoded features, one or more hidden layers using nonlinear activation functions, and an output layer producing a probability score for an open event or a click event. The server divides historical data into training, validation, and test subsets. The server performs batch training, computes gradients of the loss function with respect to the network weights using backpropagation, and updates the weights according to a learning rate parameter. The server monitors validation performance and stops training when a convergence criterion is met. This arrangement enables the server to approximate complex, nonlinear relationships in the data, beyond simple rule-based segmentation.

The server also performs emotion analysis of message content. The server retrieves message text fields from the data storage and applies a text processing pipeline, including tokenization, normalization, and feature extraction. The server employs a text-based emotion analysis technique using, for example, a neural network classifier or a lexicon-based scoring function. In the neural network case, the server uses a model architecture such as a recurrent neural network, a convolutional neural network applied to token sequences, or a transformer-based encoder. The server computes an emotional state vector or scalar scores representing sentiment polarity, emotional intensity, and category-specific scores (e.g., joy, urgency). The server stores these quantified emotional state values in association with message identifiers in the data storage.

By associating the quantified emotional state with the performance indices for each message, the server can derive correlations between emotional tone and open or click outcomes. The server calculates, for example, average open rate for messages with high positive sentiment versus neutral sentiment, or for messages with a detected “limited time” urgency pattern versus messages without urgency. This correlation analysis allows the server to generate emotion-related features, such as an “effective emotion score,” that can be used by the downstream generative AI model.

The server identifies high-performance distribution conditions based on the computed performance indices and emotion-related features. For instance, the server selects specific combinations of time slot, user segment, and content emotion pattern whose open rate and click-through rate exceed a defined threshold or fall within a top percentile. The server encodes these high-performance distribution conditions into a structured internal representation, including fields such as optimal time window, target attribute ranges, and preferred emotional tone. By structuring the data in this way, the server reduces the size of the data passed to subsequent modules and improves processing throughput, as only the most informative patterns need to be considered for proposal generation.

The server then constructs text data to be used as prompt sentences for a generative AI model. The server converts the high-performance distribution conditions and summary statistics into natural language statements according to a predefined template. The server, for example, generates text in the following form:
“You are a marketing expert for a chat-based information communication application. Based on the historical data summary below, propose the optimal send times that maximize open rate and click-through rate.
Data summary:
Weekdays 08:00-09:00: open rate 18%, click-through rate 3%, sends: 12,000
Weekdays 20:00-21:00: open rate 32%, click-through rate 7%, sends: 10,500
Weekends 10:00-11:00: open rate 25%, click-through rate 5%, sends: 8,300
Target segment: males, age 20-29, living in a given region.
Constraints: do not send more than one message per day to the same user.
Please output a concrete weekly schedule specifying days of the week and time ranges, and explain the reasoning in a concise way.”

In another example, the server constructs a prompt sentence including emotion analysis results:
“You are an AI assistant specialized in message marketing. We operate an information communication application and want to improve both open and click-through rates. Here are our analysis results:
Users aged 30-39 show the highest open rate on weekdays between 19:00 and 21:00 (open rate: 29%).
Messages that mention ‘limited time offer’ have 1.5× higher click-through rate than messages without that phrase.
Users in one region respond better to evening messages, while users in another region respond slightly better to afternoon messages.
Please propose:
1) Two recommended send time windows for each segment.
2) Three example subject lines and short message bodies that are likely to increase open and click-through rates.
Write the proposal in English and structure the output as numbered lists.”

The server assembles these prompt sentences by inserting numeric values, segment labels, and emotion indicators into pre-defined textual templates. The server uses a deterministic rule set to choose which metrics and which emotional features appear in each prompt, thereby ensuring that the generative AI model receives a consistent, machine-curated context rather than arbitrary free-form input. This structured construction of prompts is not a mere transcription of human decisions; it is executed automatically based on computations performed on large-scale datasets and predetermined selection logic, which reduces human bias and increases reproducibility.

The server invokes a generative AI model that is implemented as a neural sequence generation system. In one embodiment, the generative AI model is a transformer-based language model having multiple attention layers, layer normalization modules, and feed-forward sublayers. The model parameters are stored on a computing resource accessible to the server, and the server communicates with the model via an application programming interface over the network. The server sends the constructed prompt sentences as token sequences, and specifies parameters such as maximum output length and sampling temperature. The model then generates output tokens that are sequentially returned to the server.

The server receives the operation proposal information from the generative AI model in the form of generated text. The operation proposal information includes recommended time windows for message distribution, targeting rules for user groups, and example message contents including subject lines and body texts. The server parses the generated text according to predefined patterns, such as numbered lists or table-like descriptions, and extracts structured fields from the text. The server verifies that the proposed distribution times comply with constraints, such as maximum messages per user per day, by checking against internal rules. If necessary, the server adjusts or filters the proposed plan, thereby ensuring that the generated proposals can be executed as concrete distribution plan information.

The server stores the distribution plan information in the data storage. The distribution plan information includes references to target user attributes, scheduled time slots in system time units, and serialized message contents. The server then uses a scheduling component, such as a job queue or a scheduler service, to create tasks that will be executed at the specified times. When a scheduled time arrives, the server retrieves the relevant distribution plan, selects user identifiers matching the target conditions using database queries, and prepares outgoing message batches.

The server then calls the communication interface of the information communication application to perform the message distribution process. The server constructs request messages containing payloads with recipient identifiers and message contents, and transmits the requests through the network interface. The server monitors responses from the information communication application and records success or failure statuses, along with transmission timestamps, back into the data storage. By tightly integrating the generative AI model's outputs into the control flow that governs actual message transmission, the server achieves a closed-loop mechanism in which analysis, proposal generation, and execution are all performed by machine-executable processes.

The terminal is implemented as a user-operated computing device, such as a smartphone, tablet, or personal computer, including a display, an input device, and a network interface. The terminal executes a client application or a web browser. The terminal requests analysis summaries and operation proposal information from the server and displays the information to the user in a graphical user interface. The terminal may send configuration preferences, such as target regions or maximum campaign duration, to the server. The server integrates such preferences into the analysis and prompt construction logic.

The user interacts with the terminal to review recommended strategies and proposed message contents. The user can optionally edit the text of the messages or adjust high-level constraints; however, the computation of performance indices, the selection of high-performance distribution conditions, and the assembly of prompt sentences occur automatically at the server. This division of tasks ensures that the complex data processing and model interaction are carried out by the computing system, while the human operator focuses on oversight and final approval.

From a technical effect standpoint, the described architecture improves computer technology in several ways. First, the server employs normalized database structures and indexed queries specifically tailored for repeated analysis and iterative optimization, thereby reducing input/output overhead and improving query performance compared with unstructured log processing. Second, by pre-computing statistical and machine learning-based performance indices and encoding them into compact, structured prompt sentences, the server reduces the volume of data transmitted to the generative AI model and avoids redundant computations, which decreases network load and inference latency.

Third, the integration of quantified emotional state with performance indices enables the server to generate more informative feature representations for the generative AI model. Because the server computes emotion features and attaches them to specific content patterns, the generative AI model does not need to re-infer these properties solely from raw text input, which reduces the model's processing burden and improves overall efficiency. Additionally, by constraining the model inputs to a machine-generated prompt that encodes technical metrics and constraints, the system reduces noise and improves the precision of the generated proposals.

Fourth, the use of specific model architectures and training approaches for both the analysis phase and the generative phase enables the server to handle large-scale data in a manner that is not feasible for human operators. The server applies non-trivial optimization techniques for parameter training, monitors convergence criteria, and tunes architecture-related hyperparameters. This systematic, algorithmic approach allows the server to refine its internal models as more data are collected, resulting in continuous accuracy improvement in predicting user reactions and proposing effective distribution strategies.

Fifth, the server's rule-based parsing and validation of the generative AI model's output ensure that the operation proposal information can be transformed into executable distribution plan information without manual formatting or interpretation. The server enforces consistency checks on time formats, user segment identifiers, and content length limits before loading the proposals into the scheduler. This reduces the likelihood of runtime errors and system failures, representing an improvement in system robustness and reliability.

The combined effect of these technical measures is that the server not only automates tasks that would otherwise be done by human operators, but also enhances processing speed, prediction accuracy, and resource utilization through specific data structures, algorithmic pipelines, and machine-constructed prompt sentences. The system accordingly provides an improved computer-implemented mechanism for controlling message distribution operations through a generative AI model, achieving technical benefits in communication latency, computation efficiency, and correctness of execution that go beyond mere business rule automation.

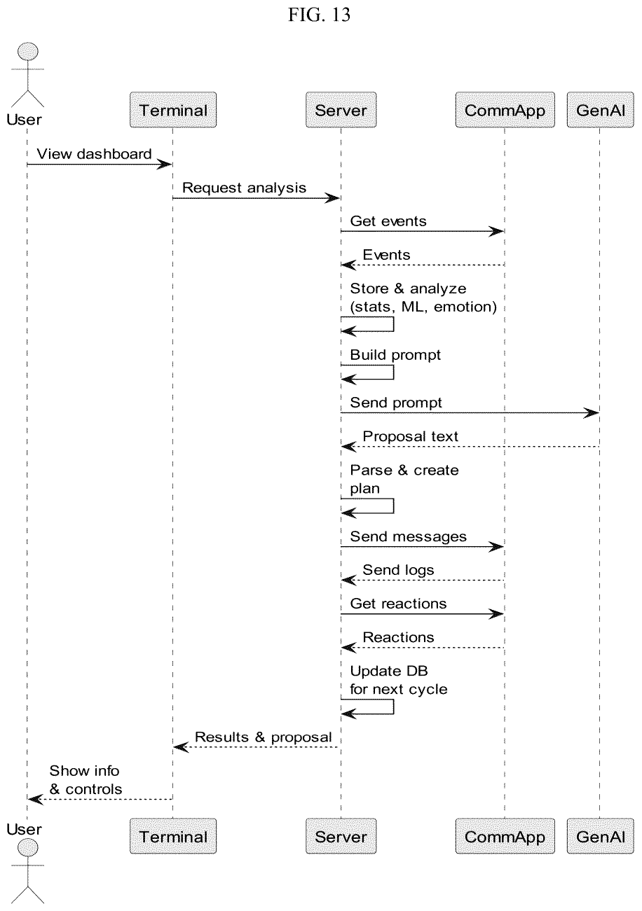

The following describes the processing flow using FIG. 13.

### Step 1:

Server acquires raw event data from the information communication application.
Server uses the network interface and an HTTP client library to send authenticated API requests to the application's communication interface.
Input: API endpoint definitions, authentication tokens, and request parameters specifying a time range or cursor position.
Server receives JSON responses including message identifiers, user identifiers, send timestamps, message text, and reaction flags such as open and click events.
Server parses the JSON payload into internal data structures, such as dictionaries or records, and converts string timestamps into a standardized time format.
Output: a collection of normalized event records representing communication history data and reaction data in memory.

### Step 2:

Server persists normalized event records into structured data storage.
Input: the in-memory collection of event records generated in Step 1.
Server connects to a relational database management system and executes insert or update operations for tables corresponding to messages, user profiles, open events, and click events.
Server checks for existing records by querying on primary keys such as message identifier and user identifier, and performs updates when reaction fields need to be added or modified.
Server commits transactions after successful batch operations to ensure durability and rolls back in case of errors.
Output: an updated database state in which all newly acquired communication history data and reaction data are stored in indexed tables.

### Step 3:

Server extracts analysis-ready datasets from the data storage.
Input: database tables for messages, user profiles, open events, click events, and campaigns, along with analysis parameters such as a time window or target user segments.
Server issues structured queries to join these tables on message identifiers and user identifiers, filtering records based on the analysis parameters.
Server loads the query results into an in-memory tabular data structure, such as a data frame, and derives additional fields including hour-of-day, day-of-week, and campaign identifiers.
Output: a consolidated analytical dataset in memory containing per-message and per-user records with aligned attributes and reaction outcomes.

### Step 4:

Server computes statistical performance indices for different distribution conditions.
Input: the analytical dataset produced in Step 3.
Server groups records by combinations of attributes, such as time slot, user attribute category, and content category, and computes aggregates including total sends, total opens, total clicks, open rate, and click-through rate.
Server calculates additional statistics, such as standard deviation and confidence intervals, for the rates within each group.
Server ranks the groups according to performance indices and marks groups that satisfy predefined thresholds as high-performance distribution conditions.
Output: a set of aggregated records, each describing a distribution condition and its associated performance indices, with flags identifying high-performance conditions.

### Step 5:

Server performs machine learning-based estimation of reaction probabilities.
Input: the analytical dataset from Step 3 and configuration parameters for a predictive model.
Server encodes categorical attributes such as time slot and user segment into numerical feature vectors and designates reaction outcomes (open or click) as target variables.
Server trains or updates a machine learning model, such as a logistic regression model or a neural network, by minimizing a loss function on the training subset of the data.
Server uses the trained model to infer predicted open and click probabilities for unobserved combinations of distribution conditions and appends these predicted values to the aggregated records.
Output: an extended set of aggregated records that include both empirical performance indices and model-predicted probabilities for each distribution condition.

### Step 6:

Server calculates and stores emotion-related features for message content.
Input: message text fields and their associated reaction data obtained from the database.
Server tokenizes and normalizes message texts and applies an emotion analysis technique, such as a neural classifier or a lexicon-based scorer, to compute numerical sentiment scores and emotion category scores.
Server associates each computed emotional state with the corresponding message identifier and aggregates the emotion scores by time slot, user segment, and content category.
Server stores the aggregated emotional features in the database, linking them to the same keys used for performance indices.
Output: a set of emotion feature records associated with content categories and distribution conditions, stored in structured tables.

### Step 7:

Server identifies high-performance distribution conditions incorporating emotional characteristics.
Input: aggregated performance indices from Step 4 and Step 5, and aggregated emotion feature records from Step 6.
Server joins these datasets on common keys, such as content category and time slot, and computes correlation measures between emotional scores and reaction metrics.
Server defines combined scores, for example a weighted sum of open rate, click-through rate, and positive emotion score, and selects conditions whose combined scores exceed a threshold.
Server compiles a list of high-performance distribution conditions that include both temporal and emotional descriptors, such as optimal time windows and recommended emotional tone.
Output: a curated list of high-performance distribution condition entries with detailed attributes and scores.

### Step 8:

Server constructs structured text summaries from the selected analysis results.
Input: the list of high-performance distribution conditions and their associated performance and emotion metrics.
Server formats each condition into natural language phrases, inserting numeric values such as open rate percentages, click-through rates, and message counts into textual templates.
Server concatenates multiple condition descriptions and a brief explanation of observed trends into a coherent summary section.
Server produces one or more summary blocks tailored to different optimization goals, such as maximizing opens or maximizing clicks.
Output: text summaries in natural language form, each describing key findings and metrics for use in prompt construction.

### Step 9:

Server generates a prompt sentence for a generative AI model.
Input: the text summaries from Step 8, constraint information such as maximum messages per user per day, and optional user-specified preferences.
Server combines a role specification for the generative AI model (for example, an instruction describing an expert role), the text summaries, and the constraints into a single, structured prompt sentence.
Server inserts list markers, headings, and question parts into the prompt so that the generative AI model can output results in a predictable structure, such as numbered lists or table-like text.
Server may generate alternative prompt variants for different tasks, such as time optimization or message content proposal, and select one based on the current operation.
Output: a finalized prompt sentence in natural language ready for submission to the generative AI model.

### Step 10:

Server sends the prompt sentence to the generative AI model and receives operation proposal information.
Input: the prompt sentence created in Step 9 and configuration parameters for the generative AI model, such as maximum output length and sampling setting.
Server transmits the prompt sentence to the generative AI model via an application programming interface and waits for the generated output tokens.
Server receives the generated text from the generative AI model and reconstructs the complete output sequence, which may include recommended distribution times, target user groups, and example message contents.
Server stores the received text in a temporary buffer for parsing and validation.
Output: operation proposal information in textual form generated by the generative AI model.

### Step 11:

Server parses and validates the generated operation proposal information.
Input: the text output produced in Step 10 and predefined parsing rules describing expected structures such as numbered items or labeled sections.
Server applies pattern matching and segmentation algorithms to extract fields such as time windows, segment definitions, and message templates from the text.
Server checks the extracted values against system constraints, such as allowed time ranges and maximum frequency per user, and resolves conflicts by discarding or adjusting non-compliant entries.
Server converts valid extracted information into a structured internal representation suitable for scheduling and execution.
Output: a validated and structured version of the operation proposal information, containing machine-readable parameters.

### Step 12:

Server generates executable distribution plan information from the structured proposal.
Input: the structured operation proposal information from Step 11.
Server maps abstract target user group definitions onto database query conditions by translating segment descriptions into attribute filters on stored user profiles.
Server translates proposed time windows into specific system timestamps or cron-like patterns according to the server's time zone and scheduling conventions.
Server encapsulates all execution parameters, including target filters, schedule definitions, and message contents, into distribution plan objects and stores them in the database.
Output: one or more distribution plan records, each fully specified for automated scheduling and execution.

### Step 13:

Server schedules and executes message distribution according to the distribution plan.
Input: distribution plan records created in Step 12 and the server's current system time.
Server employs a scheduler component to monitor the system time and trigger distribution tasks when their scheduled execution times are reached.
Server issues database queries to select user identifiers matching the target conditions for each plan and batches recipients into message sending requests.
Server calls the information communication application's communication interface to transmit messages to the selected recipients and records send results, including success or error codes, in the database.
Output: transmitted messages delivered through the information communication application and updated send logs representing executed distribution events.

### Step 14:

Server logs new reaction data and updates future analysis inputs.
Input: send logs created in Step 13 and subsequent reaction data obtained from the information communication application, such as new open and click events.
Server repeats the acquisition and storage operations similar to Step 1 and Step 2 to append the new reaction data to the existing database tables.
Server marks these records with campaign identifiers and timestamps so that they can be associated with specific distribution plans and proposals.
Server makes the newly accumulated data available for the next analysis cycle, thereby closing the feedback loop between execution and optimization.
Output: an enriched dataset of communication history data and reaction data that incorporates results from the most recent distribution plans.

### Step 15:

Terminal presents analysis results and proposals to the user and collects feedback.
Input: analysis summaries, structured proposals, and execution status information received from the server.
Terminal renders charts, tables, and text descriptions on a graphical user interface, allowing the user to understand recommended strategies and the outcomes of past distributions.
Terminal accepts user inputs such as approval, modification of constraints, or editing of message text and transmits these inputs back to the server as configuration updates.
Terminal thereby enables the user to influence high-level settings while leaving detailed data processing and generative AI interaction to the server.
Output: user feedback and updated preferences that are sent to the server for use in subsequent iterations of prompt generation and plan creation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information distribution systems that use behavioral logs and basic statistics suffer from several technical limitations when deployed at scale. A typical server collects message logs from a messaging application, computes coarse metrics such as open rates or click-through rates, and then relies on static rule sets or manually designed campaigns to control message distribution. Such architectures require human operators to continuously interpret large volumes of log data, rewrite rules, and adjust schedules. As a result, the processing pipeline from data acquisition to campaign execution becomes fragmented, latency increases, and the utilization of available computing resources is inefficient.

Furthermore, existing systems generally treat user behavior metrics and user sentiment metrics as separate analytical tracks, or ignore sentiment information altogether. Even when a sentiment analysis module is available, the integration between behavioral features and sentiment features is often ad hoc and is not formalized in the core data structures driving automated decision-making. This leads to suboptimal use of computational analysis results: the server cannot systematically generate refined control parameters for information distribution based on both behavior and emotion signals, and cannot automatically update distribution logic as new data arrives.

In addition, known uses of generative AI models in this context are typically limited to content drafting or high-level recommendations, where a human operator manually constructs input prompts and interprets the free-form output. The server is not configured to algorithmically construct prompt sentences from structured analysis results, nor to parse generated proposals into machine-usable control parameters. Consequently, the generative AI model is loosely coupled to the data-processing pipeline, which causes additional overhead, increases the number of manual configuration steps, and prevents the system from operating as a closed feedback loop.

These limitations result in several concrete technical problems: (i) the processor must repeatedly perform manual or semi-manual configuration steps, reducing throughput and increasing processing time; (ii) the storage and retrieval of behavioral and sentiment data are not tied to an iterative update of model prompts and scheduling decisions, which restricts the system's ability to adapt to changing user patterns; and (iii) the messaging interface is not automatically driven by a unified, machine-readable representation of generative AI output, which reduces the accuracy and timing precision of message distribution.

Accordingly, there is a need for a system-level technique that configures a processor to (1) automatically acquire and integrate behavioral and sentiment information from a messaging interface, (2) compute structured statistical indices and emotion feature quantities for each user or user group, (3) algorithmically construct prompt sentences for a generative AI model based on those indices and features, and (4) convert the resulting operation proposals into concrete distribution control parameters that are used to schedule and execute message distribution. There is also a need to configure the processor to operate this entire flow as a feedback loop, such that new behavioral and response history information continuously refines the prompt sentences and the resulting operation proposals. By embedding these capabilities in the core server logic, the invention aims to improve the functioning of the computer system itself, including improved automatic decisioning, reduced latency between data acquisition and campaign execution, and better utilization of processing and storage resources in the information distribution pipeline.

The specific processing by the specific processing unit 290 of the data processing device 12 in Application Example 2 is realized by the following means.

The present invention provides a server comprising a processor configured to acquire, via a program interface having a message exchange function, behavioral history information and response history information of users, to classify and store the behavioral history information and the response history information in association with time information, to calculate, by using numerical computation software, statistical indices representing user interest tendencies and behavioral patterns, to calculate, by using an emotion estimation program interface, emotion classification scores for character information included in the response history information and to generate emotion feature quantities integrated for each user, to create analysis summary data describing an information distribution plan including at least a type of information, a transmission frequency, and a transmission time slot suitable for each user or each user group, to convert the analysis summary data into natural language and generate a prompt sentence for input to a generative information processing model, to input the prompt sentence to the generative information processing model and acquire operation proposal information, to extract distribution control parameters relating to a transmission target, a transmission time, and transmission content from the operation proposal information, to automatically schedule and execute an information distribution process via the program interface having the message exchange function based on the distribution control parameters, and to feed back new behavioral history information and response history information obtained as execution results of the information distribution process into storage and to periodically recalculate the statistical indices and the emotion feature quantities including the fed-back information so as to sequentially update the prompt sentence and the operation proposal information. This enables the server to operate as an integrated feedback-control apparatus that automatically transforms raw messaging logs and sentiment information into machine-readable prompts and distribution parameters, thereby improving the efficiency, adaptability, and timing precision of information distribution processing in the computer system.

The term “processor” refers to a hardware-implemented arithmetic and logic unit, control unit, or computation device, or a combination thereof, that executes instructions of a program to perform data acquisition, analysis, generation, and control operations described in the present specification.

The term “program interface having a message exchange function” refers to an application programming interface or equivalent software interface that enables a computer system to transmit and receive message data, such as text messages or content items, between the system and user terminals over a communication network.

The term “behavioral history information” refers to data representing past actions of users with respect to messages or content, including at least message receipt events, open events, selection events, click events, viewing events, and associated timestamps.

The term “response history information” refers to data representing user reactions to messages or content, including at least reply messages, comments, feedback inputs, and other interaction records that can be expressed as character information or structured reaction data.

The term “time information” refers to temporal data, such as timestamps or time intervals, associated with behavioral history information and response history information, and used to determine time-of-day, time-slot, or chronological patterns.

The term “storage” refers to any computer-readable recording medium, including volatile or non-volatile memory, magnetic storage, optical storage, or solid-state storage, configured to store behavioral history information, response history information, statistical indices, emotion feature quantities, analysis summary data, prompts, and operation proposal information.

The term “numerical computation software” refers to a software component or library that performs numerical operations and statistical calculations, including aggregation, averaging, variance computation, and other mathematical processing on digital data.

The term “statistical indices” refers to numerical indicators computed from behavioral history information and response history information, including at least open rate, selection rate, viewing frequency, time-slot-specific engagement measures, and other metrics that characterize user interest tendencies and behavioral patterns.

The term “open rate” refers to a statistical index representing a ratio or probability that a delivered message or content item is opened or viewed by a user within a defined period.

The term “selection rate” refers to a statistical index representing a ratio or probability that a presented content option, link, or menu item is selected or clicked by a user within a defined context.

The term “viewing frequency” refers to a statistical index representing how often a user views particular messages, content categories, or content items, typically measured as a count or rate over time.

The term “time-slot-specific indices” refers to statistical indices computed for defined time segments, such as hour ranges or daily periods, indicating engagement or interaction levels of users during those time segments.

The term “interest tendencies” refers to patterns or preferences of users inferred from statistical indices, indicating favored topics, content types, or interaction contexts.

The term “behavioral patterns” refers to recurring or characteristic user behaviors over time, including typical times of activity, frequency of interactions, and response habits derived from behavioral history information.

The term “emotion estimation program interface” refers to an application programming interface or software interface configured to receive character information and output emotion classification scores or sentiment values corresponding to the character information.

The term “character information” refers to text data or symbol sequences contained in response history information, such as user comments, reply messages, or textual feedback.

The term “emotion classification scores” refers to numerical values or labels indicating emotional categories, such as positive, neutral, or negative, assigned to character information by an emotion estimation program interface.

The term “emotion feature quantities” refers to aggregated or derived numerical representations of user emotion states, obtained by integrating emotion classification scores for each user or user group over one or more messages or time periods.

The term “analysis summary data” refers to structured or semi-structured data describing results of analysis on behavioral history information, response history information, statistical indices, and emotion feature quantities, including at least an information distribution plan for each user or user group.

The term “information distribution plan” refers to a specification that defines how and when information is to be transmitted to users, including at least types of information, transmission frequency, and transmission time slots tailored to users or user groups.

The term “type of information” refers to a classification of message or content to be distributed, such as content category, topic, format, or purpose, determined for each user or user group.

The term “transmission frequency” refers to an interval, count, or rate at which messages or content items are scheduled to be transmitted to a user or user group over a specified time period.

The term “transmission time slot” refers to a designated time range, such as a specific hour or set of hours within a day, during which messages or content items are scheduled to be transmitted to a user or user group.

The term “prompt sentence” refers to a natural-language or structured textual instruction generated from analysis summary data and intended to be input to a generative information processing model to cause the model to output operation proposal information.

The term “generative information processing model” refers to a machine-learned model, such as a generative AI model, configured to receive a prompt sentence and optionally structured context as input and to generate natural-language or structured output representing operation proposal information.

The term “operation proposal information” refers to output generated by a generative information processing model that describes a recommended information distribution plan, including at least suggestions for targets, times, contents, and other parameters for information distribution.

The term “distribution control parameters” refers to machine-usable parameters derived from operation proposal information, including at least identifiers of transmission targets, transmission times, and transmission contents, which are used by the processor to control scheduling and execution of information distribution.

The term “transmission target” refers to a user, a user group, or another recipient entity specified by a distribution control parameter as a destination for messages or content.

The term “transmission time” refers to a specific time point or time interval at which a message or content item is scheduled to be transmitted as defined by a distribution control parameter.

The term “transmission content” refers to the actual message body, content item, or content template to be transmitted to a transmission target, as specified by a distribution control parameter.

The term “information distribution process” refers to a sequence of operations in which the processor, via the program interface having the message exchange function, transmits messages or content items to transmission targets in accordance with distribution control parameters.

The term “feedback” refers to the process of reintroducing newly acquired behavioral history information and response history information, obtained as execution results of the information distribution process, into storage and subsequent analysis to update statistical indices, emotion feature quantities, prompt sentences, and operation proposal information.

The term “user group” refers to a plurality of users treated as a collective unit for analysis or distribution planning, defined based on shared characteristics such as behavioral patterns, interest tendencies, or emotion feature quantities.

The term “external information processing service” refers to a remote or third-party computational service accessible via a communication network, which performs processing such as emotion analysis on provided data and returns results to the server.

The term “emotion analysis software” refers to a software component or library configured to analyze character information and output emotion classification scores or sentiment values.

The term “natural language” refers to human-readable language expressions, such as sentences or paragraphs, as opposed to binary code or purely numerical representations, and used to express prompt sentences and operation proposal information.

The term “sequentially update” refers to repeatedly revising and replacing stored prompt sentences and operation proposal information over time as new statistical indices and emotion feature quantities are recalculated using additional behavioral history information and response history information.

In one embodiment, a server implements the claimed system using a general-purpose computing platform. The server includes at least one processor, a main memory, a non-volatile storage device, a network interface, and an operating system. The server executes an information processing program that coordinates data acquisition from a messaging application, numerical and emotional analysis, construction of a prompt sentence, interaction with a generative AI model, and automatic control of information distribution via a message exchange interface.

The server uses a relational database system as storage, for example a database engine that stores tables such as user profiles, behavioral logs, response logs, statistical indices, emotion feature quantities, analysis summary data, prompt sentences, and operation proposal records. The server uses a data analysis software stack, for example a high-level programming language runtime combined with numerical computation libraries such as a matrix computation library and a tabular data processing library. The server further uses an external or internal emotion analysis service accessible via an application programming interface, and a generative AI model deployed either as a network service or as a locally hosted model.

The server configures a program interface having a message exchange function in cooperation with an existing messaging application platform. The program interface is realized, for example, as an HTTP-based API client that sends authenticated requests to the messaging application server and receives message logs and user interaction logs as structured data. The server uses a network interface controller to send and receive these API calls over a packet-switched communication network. The server maps each received record into a behavioral history information structure comprising at least a user identifier, a message identifier, a timestamp, an event type (such as received, opened, clicked, or viewed), and a content classification label. The server maps each textual reply, comment, or feedback into a response history information structure including the user identifier, a message identifier, a timestamp, and character information.

The server stores these structures in the storage as normalized database tables. For instance, a message_log table can hold message events keyed by user and time, whereas a response_log table can hold textual reactions keyed by user and time. The server associates each row with time information normalized to a unified time zone and discretized into time slots, such as 24 hourly intervals within a day. By storing data in this structured manner, the server can efficiently execute join operations and group-by aggregations using an SQL engine and a tabular data processing library. This specific data design reduces random-access overhead and improves caching efficiency when the processor loads and processes large volumes of logs.

The server applies numerical computation software to the stored behavioral history information and response history information. The server constructs in-memory data frames representing subsets of logs, each containing columns for user identifiers, timestamps, time-slot indices, and event flags (e.g., opened_flag, clicked_flag). The server then uses vectorized operations provided by the numerical libraries to derive statistical indices such as open rate (ratio of opened messages to delivered messages), selection rate (ratio of clicked messages to displayed messages), and viewing frequency (count of view events per unit time). The server further computes time-slot-specific indices by aggregating events per time slot, yielding, for each user, a distribution of engagement across the day.

This numerical processing is implemented as matrix and vector operations that exploit CPU cache locality and reduced function-call overhead. In contrast to manual spreadsheet analysis or per-event iterative loops, the use of vectorized operations and optimized numerical kernels improves processing speed and reduces energy consumption per processed record. The server thereby improves the technical performance of the computer system by reducing the time needed to compute high-dimensional statistics from large behavior logs.

The server uses an emotion estimation program interface to derive emotion classification scores from character information contained in the response history information. The server transmits batches of textual comments to an emotion analysis service or invokes a local emotion analysis module that has been previously trained using supervised machine learning. In one embodiment, the emotion analysis module is a neural network model having an embedding layer, multiple recurrent or transformer layers, and a classification head. The embedding layer maps discrete tokens into dense vectors; the sequence layers compute contextual representations; and the classification head outputs probabilities for categories such as positive, neutral, and negative. The model is trained using a cross-entropy loss function, and the processor updates the model's weights by gradient descent or a variant thereof (for example, an adaptive learning-rate optimizer) based on labeled training data.

The server converts the output probabilities into emotion classification scores and stores these scores in association with the corresponding response history records. For each user, the server aggregates emotion classification scores to compute emotion feature quantities, such as the proportion of positive reactions to a given content category, the average sentiment score in specific time slots, and temporal trends of sentiment over sliding windows. This aggregation uses the same numerical computation libraries and table structures, enabling the server to re-use optimized pipelines and maintain low latency.

The server combines the statistical indices derived from behavioral history information with the emotion feature quantities derived from response history information. The server constructs a user profile data structure that, for each user or user group, includes a vector of features: time-slot engagement distributions, content-category engagement rates, overall open and selection rates, and aggregated emotion metrics. The server optionally applies a clustering algorithm, such as k-means or a Gaussian mixture model, to group users by similarity in this feature space. Such clustering is executed by numerical routines that repeatedly compute distances, cluster centroids, and convergence criteria. By integrating behavior and emotion features in a unified vector space, the server enables more accurate and fine-grained segmentation than rule-based systems that rely on a few manually curated thresholds.

The server creates analysis summary data from the user profile data structures. The analysis summary data is structured, for example, as records containing: identifiers of users or user groups, lists of top content categories, preferred time slots, recommended transmission frequencies estimated from engagement levels, and dominant emotion tendencies per category. The server formulates an information distribution plan at this stage in the form of machine-readable parameters, but then converts this plan into natural language to form a prompt sentence for a generative AI model.

The server includes a prompt-construction routine that maps numerical features into descriptive phrases. For example, if a user has a high open rate in the 7 p.m. to 9 p.m. time-slot and shows positive sentiment toward sports-related content, the prompt-construction routine generates text such as:
“This user frequently opens messages between 7 p.m. and 9 p.m. and shows strong positive reactions to sports-related information. Based on this behavior and emotion, propose the next message content and the exact sending time to maximize engagement.”

Similarly, if another user responds positively to environmental and technology topics and negatively to financial news, the server constructs a prompt sentence such as:
“The user shows positive sentiment toward environmental and technology articles, and negative sentiment toward financial news. Suggest two article topics and sending times for tomorrow that maximize engagement and maintain a positive user experience.”

These prompt sentences follow a structured template that includes: (1) explicit statistics (open rates, time slots, category names), (2) derived sentiment summaries, and (3) a clear instruction to output a distribution strategy. This systematic mapping from structured analysis results to natural-language prompts is not a mere textual restatement; it constrains the generative model's behavior and ensures that the generated output can be later parsed into actionable control parameters. The server uses this constrained prompting to reduce variability in output and improve downstream parsing accuracy, which is a technical improvement over naive, unstructured prompt design.

The server interacts with a generative AI model that is implemented as a neural network with multiple layers. In one embodiment, the generative AI model is an autoregressive language model with transformer architecture, including a stack of self-attention blocks and feed-forward layers. The model parameters (weights and biases) are stored on specialized hardware such as graphics processing units or tensor processing units, and the server communicates with the model via a model-serving interface. The generative AI model is trained beforehand using large corpora of text and fine-tuned using examples of desired operation proposals. During training, the server or a training system minimizes a loss function such as token-level cross-entropy and uses gradient-based optimization to update weights. Data augmentation techniques, such as paraphrasing of instructions and variation of user-context descriptions, are applied to improve robustness to different prompt phrasings.

The server sends the constructed prompt sentence to the generative AI model as input and receives a generated text output representing operation proposal information. Because the prompt is constructed according to predetermined templates with consistent phrasing, the resulting output can itself be expected to follow certain patterns. The server includes a parsing module that uses text-processing rules or a secondary lightweight machine-learning model to extract distribution control parameters from the generated text. These parameters include, for example, recommended time slots (“around 8 p.m.”), content themes (“sports equipment sale, focusing on soccer”), frequency constraints (“no more than two messages per day”), and target segments (“users with high evening engagement and positive sentiment on sports topics”).

The server maps these extracted control parameters into a scheduling data structure stored in the storage. The scheduling data structure may include fields for target user identifiers or segment identifiers, selected content identifiers fetched from a content repository, transmission times normalized to the server's time base, and flags indicating whether the send should be automatic or subject to administrator approval. The server then configures a scheduler module, such as a job scheduler process, to periodically read the scheduling data structure and trigger message sends at the designated times.

The server executes the information distribution process via the program interface having the message exchange function. For each scheduled transmission, the server generates a message payload, potentially combining a pre-stored content template with personalization tokens derived from the user profile or generative AI output (for example, referencing a favored category in the message subject line). The server sends the message payload through the messaging application API, and the user receives the message on a terminal such as a smartphone or personal computer running a client application.

The terminal does not perform the core analysis but displays the delivered content and records the user's interaction behavior. When the user opens a message, clicks a link, or types a reply, the terminal transmits event notifications to the messaging platform, which in turn become part of the behavioral history information and response history information that the server later acquires. In some embodiments, the terminal also displays an administrator dashboard that presents operation proposals, distribution schedules, and performance metrics. The administrator may override or adjust certain proposals, and the terminal sends such override commands back to the server. However, the inventive technical features primarily reside in the server's automated data processing, prompting, and control algorithms.

The server closes the feedback loop by acquiring new behavioral and response history information related to the executed schedules. The server tags each new event with identifiers of the corresponding information distribution plan or operation proposal. The server periodically re-runs the numerical and emotion analysis pipelines, updating statistical indices and emotion feature quantities with the new data. Because the server operates on incremental time windows and uses efficient vectorized computations, these updates can be performed frequently without overloading the processor or storage. The server then regenerates prompt sentences that incorporate historical performance of past AI-driven campaigns, for example by adding phrases such as:
“In the last 7 days, evening campaigns achieved a 15% click-through rate, while morning campaigns achieved only 5%. Adjust the next 3 days' schedule to improve performance based on these results.”

This dynamic adjustment constitutes more than static automation; it uses the computer's ability to process large, multi-dimensional datasets and complex model outputs at high speed, in ways that are not practically achievable by human operators in real time. The specific combination of structured feature computation, constrained prompt construction, generative model interaction, and machine-parsable output extraction results in improved accuracy and timeliness of information distribution decisions. The server reduces mis-timed messages, avoids excessive messaging that might be inferred from naive rules, and selects content that exhibits empirically higher engagement according to the integrated behavior-and-emotion feature space.

From a technical perspective, the described architecture improves computer functioning in several ways. First, the integration of behavior logs and sentiment scores into compact feature vectors allows the numerical computation software to exploit linear algebra operations, significantly reducing computational complexity relative to per-user rule evaluation over raw logs. Second, the constrained prompt-construction mechanism standardizes the interface between structured data and a generative AI model, enabling deterministic parsing of outputs and eliminating manual text interpretation. This leads to lower error rates when converting natural-language proposals into machine-executable schedules. Third, the feedback loop, in which new behavior and emotion data directly influence future prompts and parameters, reduces stale configurations and supports rapid adaptation without manual reprogramming, improving system responsiveness and resource utilization.

In alternative embodiments, the server may deploy different model architectures for the emotion estimation module and the generative AI model. The emotion estimation module may be implemented as a convolutional neural network over character-level input, a recurrent neural network over word-level embeddings, or a transformer encoder; different loss functions, including margin-based losses or focal losses, may be used to handle class imbalance in sentiment labels. The generative AI model may be a sequence-to-sequence architecture that takes a structured summary as input and produces a constrained, template-like output. The server may also employ attention masks or control tokens in the prompt sentence to force the model to output in a specific format, further simplifying parsing.

In another variation, the server may not use external emotion-analysis services but instead hosts an internal model that is retrained periodically using newly labeled data, where human reviewers or semi-supervised algorithms assign emotion labels to a subset of response history information. The server may maintain versioned models and dynamically select a model version based on accuracy metrics stored in the storage. The server may similarly fine-tune the generative AI model using logs of successful and unsuccessful campaigns, thereby improving the relevance of generated operation proposals over time.

In yet another embodiment, the server may compress or index user feature vectors using dimensionality reduction techniques such as principal component analysis or autoencoder-based embeddings. This reduces the memory footprint and speeds up downstream clustering and similarity search operations when the number of users is large. The server may also shard user data across multiple physical storage devices and coordinate processing via a distributed computation framework, further improving scalability without altering the logical operation of the claimed invention.

Across these embodiments, the server, not a human operator, performs non-trivial transformations of data and model interaction protocols using specific data structures (feature vectors, summary records, scheduling tables), algorithms (vectorized aggregation, clustering, constrained prompting, parsing), and trained neural networks (emotion estimator, generative language model). The combination of these components enables the system to achieve technical effects such as higher throughput of recommendation computations, reduced latency between log acquisition and message sending, improved precision in targeting and timing, and reduced error rates in mapping AI-generated text into system-level control actions. These effects go beyond mere business process automation and constitute improvements in how the computer system processes, manages, and utilizes data for real-time control of a messaging interface.

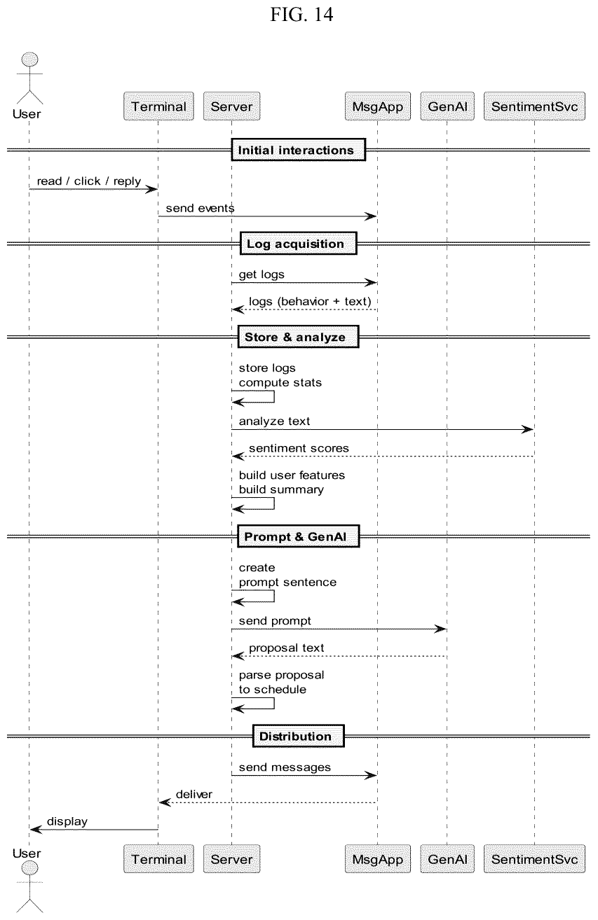

The following describes the processing flow using FIG. 14.

### Step 1:

Server acquires behavioral history information and response history information.
Server uses a message exchange program interface to send authenticated requests to a messaging application and receives message logs and user reactions as structured data (for example, JSON records).
Input: raw message delivery logs, open events, click events, view events, and user reply texts provided by the messaging application.
Output: normalized behavioral history records and response history records stored in memory or temporary buffers.
Server parses each record, extracts fields such as user identifier, message identifier, timestamp, event type, and text content, and converts them into internal data structures (for example, tables or data frames).

### Step 2:

Server stores acquired history information with associated time information.
Server writes the normalized behavioral history information and response history information into storage as relational tables or equivalent data structures.
Input: normalized behavioral history records and response history records from Step 1.
Output: persistent tables such as a message_log table and a response_log table with indexed fields for user, message, and time-slot identifiers.
Server converts timestamps into a unified time zone, computes time-slot indices (for example, hour-of-day or time-block codes), and stores these indices as additional columns to enable efficient time-based aggregation.

### Step 3:

Server calculates statistical indices from stored logs.
Server loads relevant portions of the message_log and related tables into a numerical computation environment and performs vectorized aggregation operations.
Input: stored behavioral history information for a target period, including event flags for delivered, opened, and clicked messages, and associated time-slot indices.
Output: statistical indices per user or per user group, including open rate, selection rate, viewing frequency, and time-slot-specific engagement indices.
Server groups records by user and time slot, counts events (delivered, opened, clicked, viewed), computes ratios (for example, opens/delivered), and stores results into a statistics table or an in-memory feature matrix.

### Step 4:

Server derives emotion classification scores from response history information.
Server submits batches of character information (user comments or replies) to an emotion estimation program interface or local emotion analysis module.
Input: text data extracted from response_log entries, including user identifiers, timestamps, and raw comment strings.
Output: emotion classification scores and labels (for example, positive, neutral, negative) associated with each response record.
Server tokenizes each text, encodes it per the emotion model's requirements, sends it to the model, receives probability distributions over emotion categories, and converts them into numeric scores and discrete labels, which are written back into an emotion_log or appended as columns to the response_log.

### Step 5:

Server aggregates emotion classification scores into emotion feature quantities.
Server processes the emotion_log or enriched response_log to compute user-level emotion summaries.
Input: per-response emotion scores and labels from Step 4, combined with user identifiers, content categories, and time-slot indices.
Output: emotion feature quantities per user or per user group, such as average sentiment per category, ratio of positive reactions by time slot, and sentiment trend indicators.
Server groups responses by user, content category, and time slot, computes averages, proportions, and moving averages of sentiment scores, and stores these aggregates in an emotion_features table or feature matrix.

### Step 6:

Server combines statistical indices and emotion feature quantities into user profiles.
Server joins the statistics table and the emotion_features table using user identifiers (and optionally content categories) to create unified feature vectors.
Input: statistical indices per user from Step 3 and emotion feature quantities per user from Step 5.
Output: user profile structures containing combined behavior-and-emotion feature vectors for each user or user group.
Server performs table joins, resolves missing values, normalizes feature scales if necessary, and writes the resulting profiles into a user_profiles table for later use.

### Step 7:

Server optionally segments users based on combined features.
Server applies a clustering or segmentation algorithm to group users into segments with similar behavior and sentiment patterns.
Input: user profile feature vectors from Step 6.
Output: segment labels or cluster identifiers assigned to each user.
Server runs a clustering algorithm (for example, k-means) that takes the feature matrix as input, iteratively updates cluster centers and assignments, and stores the final segment ID for each user in a user_segments table.

### Step 8:

Server generates analysis summary data describing information distribution plans.
Server converts numerical indices and emotion features into structured summary records per user or segment, indicating recommended content types, transmission frequencies, and preferred time slots.
Input: user profiles and, if available, segment labels from Steps 6 and 7.
Output: analysis summary data structures containing, for each user or user group, key metrics and preliminary distribution parameters.
Server applies algorithmic rules, such as mapping higher engagement in a time slot to a higher distribution score, and determines candidate time windows and content themes, then records these decisions in an analysis_summary table.

### Step 9:

Server constructs a prompt sentence for a generative AI model.
Server maps each analysis summary record into a natural-language description that encodes user behavior, sentiment patterns, and a specific request for a distribution strategy.
Input: analysis summary data from Step 8, including engagement metrics, sentiment summaries, and candidate plan parameters.
Output: one or more prompt sentences formatted as natural-language instructions for a generative AI model.
Server fills a predefined template with measured statistics and emotion summaries, for example:
“This user frequently opens messages between 7 p.m. and 9 p.m. and shows strong positive reactions to sports-related information. Based on this behavior and emotion, propose the next message content and the exact sending time to maximize engagement.”
and
“The user shows positive sentiment toward environmental and technology articles, and negative sentiment toward financial news. Suggest two article topics and sending times for tomorrow that maximize engagement and maintain a positive user experience.”
The server saves these prompt sentences in a prompts table and prepares them as inputs to the generative AI model.

### Step 10:

Server sends the prompt sentence to the generative AI model and obtains operation proposal information.
Server invokes a generative AI model service, passing the prompt sentence as input and receiving generated text as output.
Input: prompt sentences from Step 9, optionally accompanied by structured context such as user identifiers or segment identifiers.
Output: natural-language operation proposal information describing recommended information distribution plans.
Server sends an API request containing the prompt text, receives a generated response, and stores the response text in an operation_proposals table linked to the originating prompt and user or segment.

### Step 11:

Server parses operation proposal information into distribution control parameters.
Server analyzes the generated text to extract concrete parameters such as transmission target, transmission time, content type, and any constraints.
Input: natural-language operation proposal information from Step 10.
Output: structured distribution control parameters suitable for scheduling and sending messages.
Server uses pattern-matching rules, keyword extraction, or a lightweight parsing model to identify time expressions (for example, “around 8 p.m.”), topic descriptions (for example, “sports equipment sale, focusing on soccer”), and frequency rules, and maps them into normalized fields in a control_parameters table.

### Step 12:

Server schedules information distribution based on distribution control parameters.
Server creates scheduling entries specifying when and to whom messages or content items should be transmitted.
Input: distribution control parameters from Step 11 and content catalog information stored in the content repository.
Output: scheduled distribution records defining transmission times, target users or segments, and selected content identifiers.
Server resolves content type descriptions to specific content IDs, assigns precise timestamps based on recommended time slots, and inserts scheduling records into a send_schedule table monitored by a scheduler module.

### Step 13:

Server executes information distribution via the messaging program interface.
Server triggers the sending of messages or content items at the scheduled times by calling the messaging application's API.
Input: scheduled distribution records from Step 12 indicating user identifiers, message templates, and send times.
Output: transmitted messages delivered to user terminals and corresponding delivery status records.
Server constructs message payloads, personalizes text if required, sends API requests to the messaging platform, and records send results (success, failure, error codes) in a delivery_log table.

### Step 14:

User receives and acts on distributed information.
User views messages, opens links, and optionally sends replies or reactions using a client application on a terminal.
Input: messages delivered from the server via the messaging platform.
Output: user interaction events such as opens, clicks, and reply texts, which are captured by the messaging platform.
User reads content, decides whether to interact, and performs actions that create new behavioral history information and response history information.

### Step 15:

Terminal records and sends user interaction data.
Terminal, running the client application, detects user actions (for example, message open events and click events) and transmits them to the messaging platform backend.
Input: low-level user interaction events generated by user operations on the client UI.
Output: event notifications that are forwarded to the server as part of updated logs in subsequent acquisition cycles.
Terminal packages interaction metadata (message ID, time, action type) and submits it to the messaging service, which then becomes available to the server through the message exchange program interface.

### Step 16:

Server closes the feedback loop by updating stored data and recalculating features.
Server periodically repeats Steps 1 through 6 using newly acquired logs that correspond to executed information distribution plans.
Input: new behavioral history information and response history information generated after the latest distribution cycle.
Output: updated statistical indices, emotion feature quantities, user profiles, analysis summary data, prompt sentences, and operation proposals.
Server merges new logs into existing tables, updates feature vectors using incremental aggregation, and regenerates prompt sentences that now include performance metrics of previous proposals, thus continuously refining future distribution strategies.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

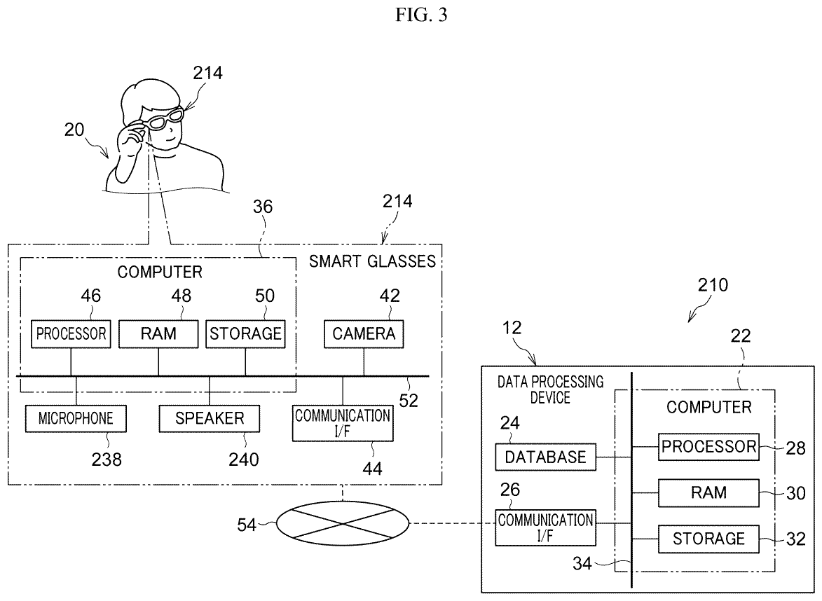

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

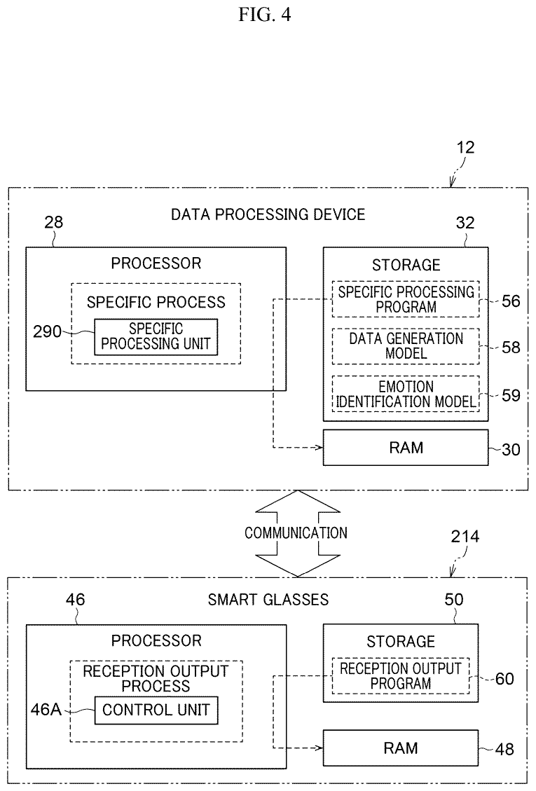

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

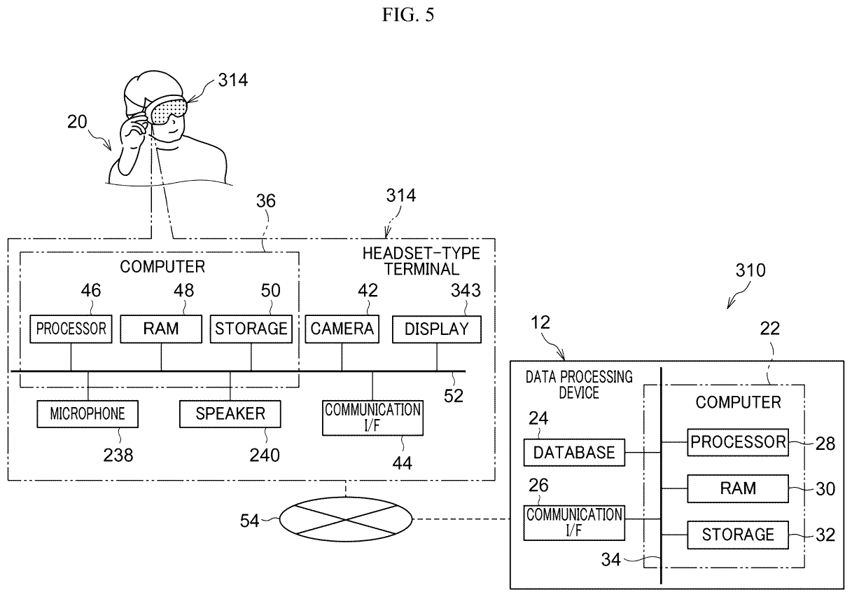

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

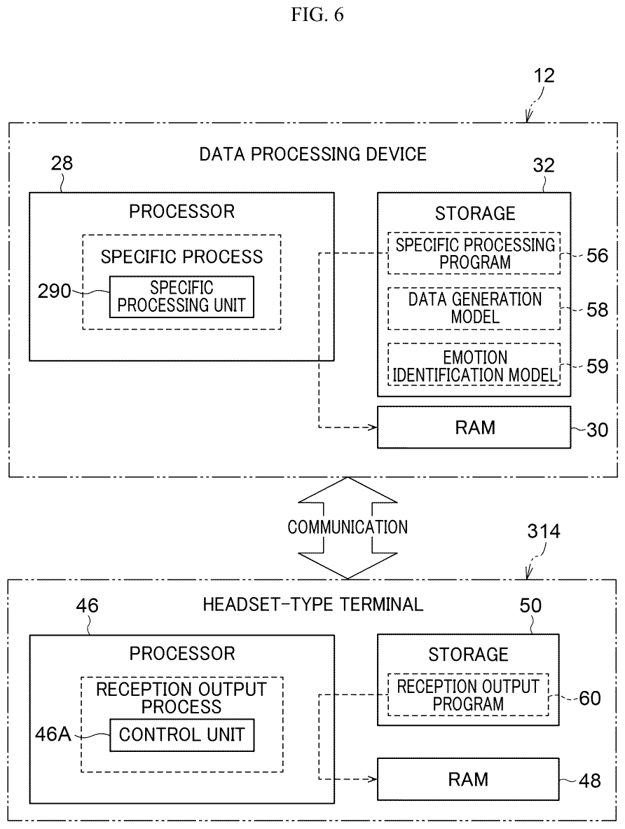

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

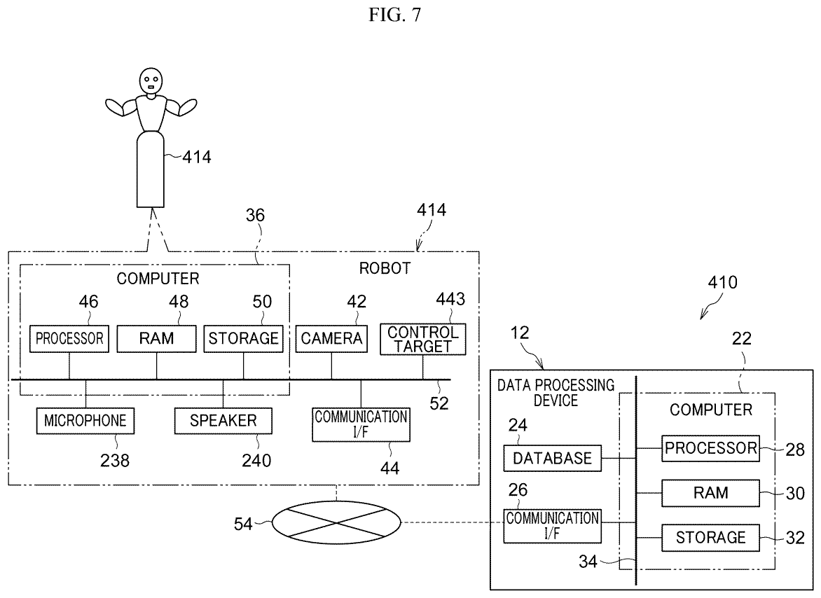

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

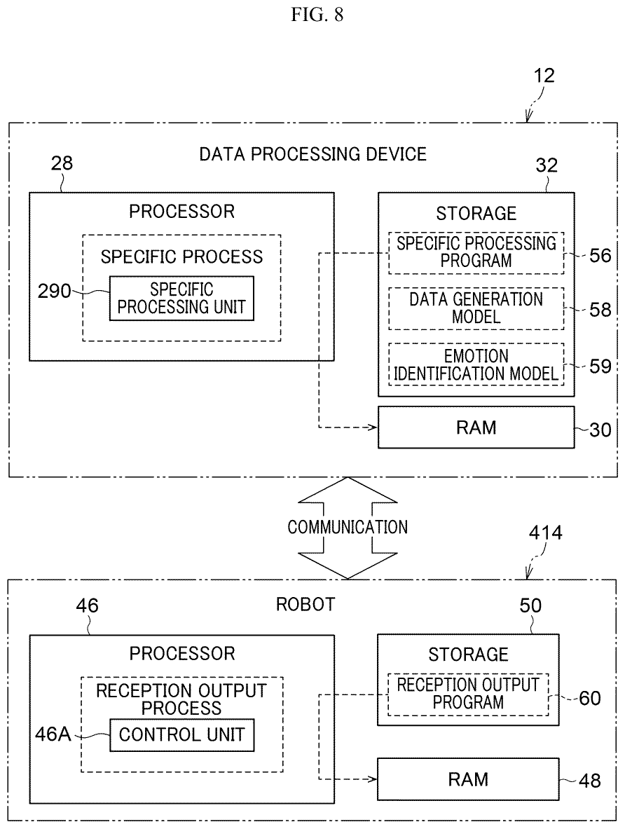

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

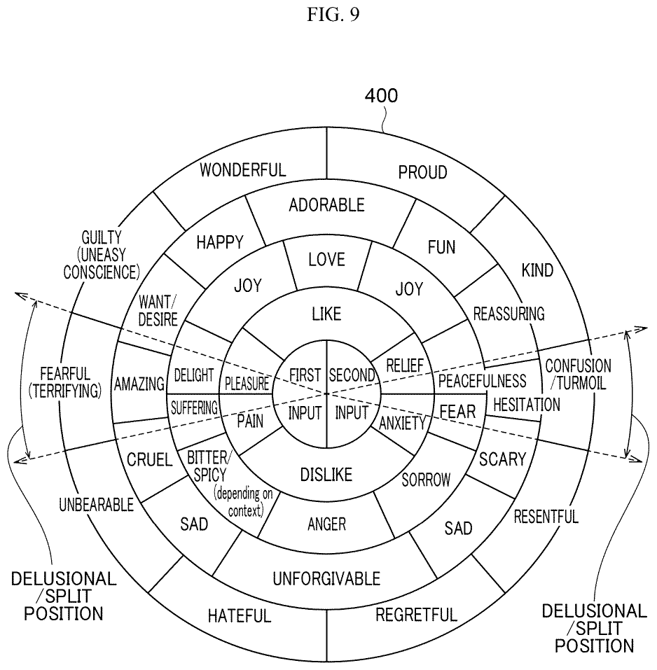

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

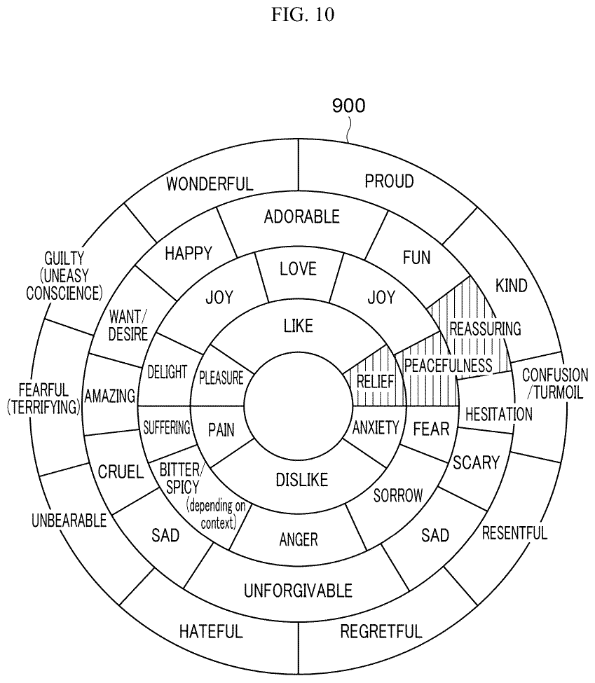

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
connect, via a communication function, to an application programming interface of an information providing application and acquire performance information related to a user, thereby collecting, for a predetermined period, performance information including viewing indicators, selection indicators, reaction indicators, and time information for distributed information,
read the performance information from a storage device and assign time attributes based on the time information by using a general-purpose information processing program, and execute aggregation processing and trend extraction processing for each time attribute by using a statistical processing program or a machine learning program, thereby identifying tendencies of the viewing indicators, the selection indicators, and the reaction indicators for predetermined time zones or dates,
construct analysis results indicating the tendencies as explanation information in a natural language format and generate an instruction sentence including the explanation information, thereby generating a prompt sentence that instructs a generative AI model to create an operation proposal,
input the prompt sentence to an external generative AI model or an internal generative AI model and obtain, in a natural language format, operation proposal information regarding distribution time and distribution content based on the analysis results, and
configure the operation proposal information as notification data to be notified to a terminal device and transmit the notification data toward the terminal device so that a user can view the operation proposal information.

### Supplementary 2

The system according to supplementary 1,
wherein the processor is configured to analyze expression information acquired from the user by using a text analysis program, calculate an emotion index as numerical information indicating an emotional state, and provide the emotion index to the generative AI model by including the emotion index in the prompt sentence.

### Supplementary 3

The system according to supplementary 1,
wherein the processor is configured to input the prompt sentence and the emotion index to the generative AI model and cause the generative AI model to generate the operation proposal information based on both tendencies of the performance information and the emotion index.

### Application Example 1

### Supplementary 1

A system comprising a processor,
wherein the processor is configured to
acquire user history information via a messaging communication interface and store the user history information in a storage unit,
analyze the stored user history information using a statistical method and a machine learning method to generate, for each user, a user profile indicating an interest tendency and a behavioral characteristic, and select delivery candidate information on the basis of the user profile,
construct a prompt sentence, on the basis of the user profile and a content of the delivery candidate information, the prompt sentence being configured to instruct a generative AI model to generate summary information and proposal information, input the prompt sentence into the generative AI model, and obtain the summary information and the proposal information from the generative AI model,
transmit delivery information including the obtained summary information and the proposal information to a user terminal via the messaging communication interface,
and acquire reaction information to the delivery information from the user terminal, convert the reaction information into a quantitative evaluation value, and reflect the quantitative evaluation value in the user profile and in a selection condition for the delivery candidate information so as to optimize delivery information for a subsequent delivery.

### Supplementary 2

The system according to supplementary 1,
wherein the processor is configured to generate the prompt sentence by adding, to the prompt sentence, an instruction sentence that explicitly specifies a summary length, a language, a difficulty level of expression, and a subject to be emphasized, on the basis of an interest field, a preferred information amount, a preferred expression style, and past reaction information included in the user profile, such that an output content of the generative AI model is dynamically adjusted for each user.

### Supplementary 3

The system according to supplementary 1,
wherein the processor is configured to acquire, as the reaction information, behavior log information including a viewing state, a selection operation, an evaluation operation, and a response text with respect to the delivery information, calculate a preference index for each topic and an effectiveness index for each delivery condition by using the behavior log information, and update the user profile and a generation rule of the prompt sentence on the basis of the calculated indexes so as to sequentially optimize a generation process of the summary information and the proposal information by the generative AI model.

### Example 2

### Supplementary 1

A system comprising a processor,
wherein the processor is configured to
acquire communication history data and reaction data of users from an information communication application via a communication interface of the information communication application over an information communication network, and store the acquired data in a data storage,
classify the stored communication history data and reaction data based on at least one viewpoint selected from a time slot, a user attribute, and a distribution content, and calculate performance indices related to open rates and click-through rates by using statistical processing and machine learning processing, thereby identifying high-performance distribution conditions as analysis results,
generate text data including the identified high-performance distribution conditions and summary information derived from the analysis results, and construct a prompt sentence for input to a generative AI model based on the text data,
input the constructed prompt sentence to the generative AI model, and cause the generative AI model to generate operation proposal information relating to at least a distribution time, a target user group, and a message content on the basis of the high-performance distribution conditions and the performance indices, and
generate distribution plan information based on the generated operation proposal information, execute a message distribution process through the communication interface of the information communication application in accordance with the distribution plan information, and store, as new communication history data and reaction data, a result of the message distribution process in the data storage so as to enable repeated execution of the analysis and the generation of the operation proposal information.

### Supplementary 2

The system according to supplementary 1,
wherein the processor is configured to
analyze an emotional state included in a message content by using an emotion analysis technique, quantify the emotional state, associate the quantified emotional state with the performance indices, and include information indicating the emotional state in the prompt sentence.

### Supplementary 3

The system according to supplementary 1,
wherein the processor is configured to
input the prompt sentence and information relating to the quantified emotional state obtained by the emotion analysis technique to the generative AI model in combination, and cause the generative AI model to generate, as the operation proposal information, a proposal in which at least one of the distribution time, the target user group, and the message content is adjusted based on a combination of the emotional state, the distribution conditions, and the performance indices.

### Application Example 2

### Supplementary 1

A system comprising a processor,
wherein the processor is configured to
acquire, via a program interface having a message exchange function, behavioral history information and response history information of users, classify the behavioral history information and the response history information for each user and for each information item, associate the behavioral history information and the response history information with time information, and store the behavioral history information and the response history information in a storage,
calculate, by using numerical computation software, statistical indices including at least an open rate, a selection rate, a viewing frequency, and time-slot-specific indices on the basis of the stored behavioral history information and response history information, and identify interest tendencies and behavioral patterns of the users on the basis of the statistical indices, calculate, by using an emotion estimation program interface, emotion classification scores for character information included in the response history information, associate the emotion classification scores with the statistical indices, and generate emotion feature quantities integrated for each user,
create, on the basis of the statistical indices and the emotion feature quantities, analysis summary data describing an information distribution plan including at least a type of information, a transmission frequency, and a transmission time slot suitable for each user or each user group, convert the analysis summary data into natural language, and generate a prompt sentence for input to a generative information processing model,
input the prompt sentence to the generative information processing model to acquire operation proposal information, extract, from the operation proposal information, distribution control parameters relating to a transmission target, a transmission time, and transmission content, and automatically schedule and execute, on the basis of the distribution control parameters, an information distribution process via the program interface having the message exchange function, and
feed back, to the storage, new behavioral history information and response history information acquired as execution results of the information distribution process, and periodically recalculate the statistical indices and the emotion feature quantities including the fed-back information so as to sequentially update the prompt sentence and the operation proposal information.

### Supplementary 2

The system according to supplementary 1,
wherein the processor is configured to cause the emotion estimation program interface to classify the character information, via an external information processing service or emotion analysis software, into a plurality of emotion categories including at least a positive category, a neutral category, and a negative category, to quantify an occurrence degree for each of the emotion categories as an emotion score, and to include the emotion score in the emotion feature quantities.

### Supplementary 3

The system according to supplementary 1,
wherein the processor is configured to cause the generative information processing model to generate, in natural language, the operation proposal information indicating the information distribution plan for each user or each user group, by using as input the prompt sentence and the analysis summary data including the emotion feature quantities, and to automatically perform selection of distribution targets, determination of transmission time slots, and selection of information content for the information distribution process on the basis of the operation proposal information.

What is claimed is:

1. A system comprising:
circuitry configured to
connect, via a packet-switched network, to an application programming interface of an information distribution platform and acquire interaction metric data associated with a plurality of user accounts for a predetermined collection period,
store the interaction metric data in a data repository, assign temporal attribute values to the interaction metric data based on timestamp information, and execute aggregation processing and trend extraction processing on the interaction metric data for each temporal attribute value using at least one of a statistical computation module and a machine learning model,
construct, from a result of the trend extraction processing, explanation data in a natural language format and generate a structured input sequence for a generative neural network model, the structured input sequence including the explanation data and an instruction segment that causes the generative neural network model to produce output recommendation data, and
transmit, via the packet-switched network, the output recommendation data to a terminal device for rendering on a display of the terminal device.

2. The system according to claim 1, wherein the interaction metric data comprises at least a viewing indicator value, a selection indicator value, and a reaction indicator value for each distributed information item, and wherein the trend extraction processing identifies temporal patterns of the viewing indicator value, the selection indicator value, and the reaction indicator value across predetermined time segments.

3. The system according to claim 2, wherein the circuitry is further configured to:
compute, for each predetermined time segment, a composite engagement score by applying a weighted aggregation function to the viewing indicator value, the selection indicator value, and the reaction indicator value, and
include the composite engagement score in the explanation data provided to the generative neural network model.

4. The system according to claim 3, wherein the output recommendation data comprises at least one of a distribution timing recommendation, a content characteristic recommendation, and a target segment recommendation generated by the generative neural network model based on the composite engagement score and the temporal patterns.

5. The system according to claim 1, wherein the circuitry is further configured to:
apply a text analysis module to expression data associated with the plurality of user accounts to compute an affective index value representing a quantified emotional state of each user account, and
include the affective index value in the structured input sequence for the generative neural network model, thereby causing the generative neural network model to incorporate the affective index value when producing the output recommendation data.

6. The system according to claim 5, wherein the text analysis module applies at least one of a sentiment classification neural network and a lexicon-based scoring function to character sequence data extracted from user interaction records to produce the affective index value as a numerical score on a predefined scale.

7. The system according to claim 6, wherein the circuitry is further configured to:
map the affective index value to an affective category label using a predefined threshold mapping, and
append the affective category label to the structured input sequence as a conditioning parameter for the generative neural network model.

8. The system according to claim 1, wherein the machine learning model comprises at least one of a clustering algorithm that groups the plurality of user accounts into behavioral segments and a regression model that predicts future interaction metric data based on historical interaction metric data.

9. The system according to claim 8, wherein the circuitry is further configured to:
generate a user profile data record for each user account based on the behavioral segment assignment, and
include a representation of the user profile data record in the structured input sequence for the generative neural network model.

10. The system according to claim 9, wherein the user profile data record comprises at least one of a preference attribute vector, an activity frequency indicator, and a response pattern descriptor, and wherein the circuitry selects a prompt template from a plurality of stored prompt templates based on the behavioral segment assignment.

11. The system according to claim 1, wherein the generative neural network model is a transformer-based language model comprising a plurality of self-attention layers, and wherein the circuitry encodes the structured input sequence into token identifiers processed through the plurality of self-attention layers to produce the output recommendation data in an auto-regressive token generation process.

12. The system according to claim 1, wherein the circuitry is further configured to:
receive, via the packet-switched network, a feedback signal from the terminal device indicating a user evaluation of the output recommendation data, and
update at least one of the machine learning model parameters and a prompt template selection rule based on the feedback signal.

13. The system according to claim 1, wherein the circuitry is further configured to:
execute a scheduling module that determines, based on the output recommendation data, a distribution timing parameter for subsequent information items, and
transmit the distribution timing parameter to the information distribution platform via the application programming interface.

14. The system according to claim 13, wherein the scheduling module computes the distribution timing parameter by correlating peak engagement time segments identified in the trend extraction processing with the output recommendation data from the generative neural network model.

15. The system according to claim 1, wherein the circuitry is further configured to:
apply an affective state classifier to audio signal data received from the terminal device to determine an affective state label of a user, and
incorporate the affective state label into the structured input sequence for the generative neural network model.

16. The system according to claim 1, wherein the circuitry is further configured to:
receive, via the packet-switched network, image frame data from an image acquisition device of the terminal device,
apply a convolutional neural network-based expression classification model to the image frame data to determine an expression label, and
incorporate the expression label into the structured input sequence for the generative neural network model.

17. The system according to claim 1, wherein the circuitry is further configured to:
store, in the data repository, a record associating the structured input sequence, the output recommendation data, and a subsequent change in the interaction metric data, and
compute, from a plurality of such records, an effectiveness score for the output recommendation data to refine future trend extraction processing.

18. A system comprising:
circuitry configured to
connect, via a packet-switched network, to an application programming interface of an information distribution platform and acquire interaction metric data for a plurality of user accounts,
execute trend extraction processing on the interaction metric data using a machine learning model to identify temporal patterns,
apply a text analysis module to expression data associated with the plurality of user accounts to compute an affective index value,
generate a structured input sequence for a generative neural network model, the structured input sequence comprising explanation data derived from the temporal patterns, the affective index value, and an instruction segment,
acquire output recommendation data from the generative neural network model based on the structured input sequence, and
transmit, via the packet-switched network, the output recommendation data to a terminal device.

19. The system according to claim 18, wherein the circuitry is further configured to:
generate a user profile data record for each user account based on behavioral segment assignment from the machine learning model, and
include the user profile data record and the affective index value in the structured input sequence, thereby causing the generative neural network model to produce personalized output recommendation data for each behavioral segment.

20. A method performed by a system comprising circuitry, the method comprising:
connecting, via a packet-switched network, to an application programming interface of an information distribution platform and acquiring interaction metric data associated with a plurality of user accounts for a predetermined collection period;
storing the interaction metric data in a data repository, assigning temporal attribute values to the interaction metric data based on timestamp information, and executing aggregation processing and trend extraction processing on the interaction metric data for each temporal attribute value using at least one of a statistical computation module and a machine learning model;
constructing, from a result of the trend extraction processing, explanation data in a natural language format and generating a structured input sequence for a generative neural network model, the structured input sequence including the explanation data and an instruction segment that causes the generative neural network model to produce output recommendation data; and
transmitting, via the packet-switched network, the output recommendation data to a terminal device for rendering on a display of the terminal device.
